(19) United States
(12) Patent Application Publication
(10) Pub. No.: US 2019/0156313 A1
(43) Pub. Date: May 23, 2019

(54) ACCOUNT LINKING SYSTEM AND METHOD

(71) Applicants: Omesh A. Persaud, Highlands Ranch, CO (US); Lori D. Van Deloo, Los Altos, CA (US); Chris J. Truelson, Highlands Ranch, CO (US); Zack Fuerstenberg, Toronto (CA)

(72) Inventors: Omesh A. Persaud, Highlands Ranch, CO (US); Lori D. Van Deloo, Los Altos, CA (US); Chris J. Truelson, Highlands Ranch, CO (US); Zack Fuerstenberg, Toronto (CA)

(21) Appl. No.: 16/165,927

(22) Filed: Oct. 19, 2018

Related U.S. Application Data
(63) Continuation of application No. 13/487,033, filed on Jun. 1, 2012, now abandoned.
(60) Provisional application No. 61/492,346, filed on Jun. 1, 2011.

(51) Int. Cl. G06Q 20/20; G06Q 20/34; G06Q 20/40

(52) U.S. Cl. CPC G06Q 20/20; G06Q 20/405; G06Q 20/35785

(57) ABSTRACT

Embodiments of the invention are directed to a relationship payment system that allows the establishment of a linked relationship between a primary account of a primary user and a secondary account of a secondary user. The relationship payment system allows a primary user to designate a portion of a credit limit of a primary user's account to grant to a secondary user's account. Transactions are authorized against secondary user's account, and then ultimately clearing and settlement for the transactions is conducted against the primary user's account.

### CROSS-REFERENCES TO RELATED APPLICATIONS

This application is a non-provisional application of and claims the benefit of priority of U.S. Provisional Application No. 61/492,346, filed on Jun. 1, 2011, which is herein incorporated by references in its entirety for all purposes.

### BACKGROUND

As the means of conducting transactions have increasingly shifted towards the use of payment devices in lieu of banknotes with set cash values, the need for methods of controlling and managing the use of payment devices has correspondingly increased. This is even more the case when a payment device of an individual is linked to a primary account of another individual. For example, an employee or a dependent (e.g. child, student, etc.) may possess a payment device linked to an employer or parent, respectively.

When accounts are linked, the primary account holder (e.g. employer, parent, etc.) may want to establish certain controls over the use of the linked account, particularly with respect to any credit limit granted to the linked account by the primary account holder.

However, where there is a linked account relationship, transaction processing may require transaction authorizations to be conducted against the linked account, while transaction clearing and settlement may be required to be conducted against the primary account. There may also be a need to terminate the linkage and restore the linked account as an independent and distinct account.

In prior solutions, when a transaction was conducted by a secondary user with a secondary account linked to a primary account, the authorization request message was modified by the payment processing network prior to being sent to an issuer computer. The account identifier of the secondary account was replaced with the account identifier of the primary account. Thus, in this solution, the reconciliation process was conducted directly against the primary account.

One of the problems stemming from this solution is that when the secondary user wants a chargeback (e.g. fraudulent charge, returning a purchased item, etc.), as the reconciliation was done solely against the primary account, the merchant had no records of a settlement with the secondary account. Implementations to solve this problem would require additional processing and systems to switch the account and transaction data back and forth between the primary account and the secondary account.

Other prior solutions transferred actual funds from a primary account to a secondary (or linked) account as a cash advance, such that the open-to-buy limit of the primary would be reduced and an actual charge would be posted against the primary account in the amount of the transferred funds.

One of the problems that arises with this previous solution is that once the funds have been transferred from the primary account to the secondary account, the funds are treated as spent by the primary account. Thus, even though the funds have not actually been spent by the secondary account, by virtue of the funds being moved from the primary account to the secondary account, the amount of the funds granted to the secondary account are subject to a reconciliation process, as well as interest fees.

Thus, new and enhanced methods of providing for the linkage of separate accounts of separate users that solves the above problems has become necessary to provide greater user services and account management capabilities while preserving and utilizing existing systems and messaging capabilities.

Embodiments of the invention address the above problems, and other problems, individually and collectively.

### BRIEF SUMMARY

Embodiments of the present invention are related to systems and methods for creating and terminating links between a first payment device of a primary user and a second payment device of a secondary user. Embodiments are further related to processing transactions involving the secondary payment device where clearing and settlement for the transactions is conducted against the account of the first payment device.

One embodiment of the invention is directed to a method comprising receiving, by a server computer, an authorization request message wherein the authorization request message requests authorization to conduct a transaction for a transaction amount using a second account of a secondary user, wherein the transaction is conducted between the secondary user and a payee. The method may further comprise receiving a settlement file comprising transaction details for the transaction, and initiating, by a computer, the transfer of funds from a first account of a primary user to the payee.

Another embodiment of the invention is directed to a server computer comprising a processor, and a computer readable medium coupled to the processor, the computer readable medium comprising code for implementing a method. The method comprises receiving, by a server computer, an authorization request message wherein the authorization request message requests authorization to conduct a transaction for a transaction amount using a second account of a secondary user, wherein the transaction is conducted between the secondary user and a payee. The method may further comprise receiving a settlement file comprising transaction details for the transaction, and initiating, by a computer, the transfer of funds from a first account of a primary user to the payee.

Another embodiment of the invention is directed to a method comprising providing configuration data, by a client computer, the configuration data indicating an allocation of a predetermined amount of an account limit of the second account, to link the first account to the second account, wherein an authorization hold on the first account for the predetermined amount is thereafter initiated, and the second account is thereafter used to conduct a transaction, which is settled against the first account. The method further comprises providing severance data, wherein the severance data unlinks the first account and the second account.

Another embodiment of the invention is directed to a client computer comprising a processor, and a computer readable medium comprising code, executable by the processor for implementing a method. The method comprises providing configuration data, by a client computer, the configuration data indicating an allocation of a predetermined amount of an account limit of the second account, to link the first account to the second account, wherein an authorization hold on the first account for the predetermined amount is thereafter initiated, and the second account is thereafter used to conduct a transaction, which is settled against the first account. The method further comprises providing severance data, wherein the severance data unlinks the first account and the second account.

Another embodiment of the invention is directed to a method comprising receiving configuration data linking a first account comprising a first identifier and a second account comprising a second identifier, where the first account is associated with a first issuer and the second account is associated with a second issuer. The method further comprises receiving an authorization request message comprising a second account identifier and transmitting the second account identifier to a second issuer. An authorization response message is received from the second issuer and send to the payee. The method further comprises receiving a settlement file from the payee or an acquirer associated with the payee, parsing the settlement file, and providing settlement information in the settlement file to a first issuer computer associated with the first issuer.

Another embodiment of the invention is directed to a client computer comprising a processor, and a computer readable medium comprising code, executable by the processor for implementing a method. The method comprises receiving configuration data linking a first account comprising a first identifier and a second account comprising a second identifier, where the first account is associated with a first issuer and the second account is associated with a second issuer. The method further comprises receiving an authorization request message comprising a second account identifier and transmitting the second account identifier to a second issuer. An authorization response message is received from the second issuer and send to the payee. The method further comprises receiving a settlement file from the payee or an acquirer associated with the payee, parsing the settlement file, and providing settlement information in the settlement file to a first issuer computer associated with the first issuer.

Although first and second accounts, and primary and secondary accounts, are discussed in detail, embodiments of the invention are not limited to only two accounts. For example, there could be third, fourth, fifth, etc. accounts linked to a primary account (or even a secondary account) in other embodiments of the invention.

These and other embodiments of the invention are described in further detail below with reference to the Figures and the Detailed Description.

### BRIEF DESCRIPTION OF THE DRAWINGS

FIG. 1 shows a system diagram of a payment processing system according to an embodiment of the claimed invention.

FIG. 2 shows a block diagram of components of a payment processing network according to an embodiment of the invention.

FIG. 3 shows a block diagram of components of an account configuration server computer according to an embodiment of the invention.

FIG. 4 shows a depiction of a configuration interface for establishing a link between a primary account and a secondary account, according to an embodiment of the invention.

FIG. 5 shows a table containing information regarding customizable settings for linked accounts according to an embodiment of the invention.

FIG. 6 illustrates a flowchart describing the process of enrolling a secondary account and setting up the secondary account for use in transactions according to an embodiment of the invention.

FIG. 7 illustrates a flowchart describing the process of paying for a transaction using a linked account according to an embodiment of the invention.

FIG. 8 illustrates a flowchart describing the clearing and settlement process using a linked payment account according to an embodiment of the invention.

FIG. 9 illustrates a flowchart describing a chargeback process using a linked payment account in the system.

FIG. 10 illustrates a flowchart describing the process of terminating a link between a primary account and a secondary account according to an embodiment of the invention.

FIG. 11 shows a system diagram of a payment processing system with two issuer computers according to an embodiment of the claimed invention.

FIG. 12 illustrates a flowchart describing the process of enrolling a secondary account and setting up the secondary account for use in transactions according to an embodiment of the invention as depicted in FIG. 11.

FIG. 13 illustrates a flowchart describing the process of paying for a transaction using a linked account according to an embodiment of the invention as depicted in FIG. 11.

FIG. 14 illustrates a flowchart describing the clearing and settlement process using a linked payment account according to an embodiment of the invention as depicted in FIG. 11.

FIG. 15 illustrates a flowchart describing a chargeback process using a linked payment account in the system as depicted in FIG. 11.

FIG. 16 illustrates a flowchart describing the process of terminating a link between a primary account and a secondary account according to an embodiment of the invention as depicted in FIG. 11.

FIG. 17 shows a block diagram of a computer apparatus.

### DETAILED DESCRIPTION

Prior to discussing embodiments of the invention, descriptions of some terms may be helpful in understanding embodiments of the invention.

The term “authorization request message” may include a message sent as part of an authorization process for a financial transaction. It may be a message that is sent from a merchant requesting that an issuer authorize a financial transaction. An authorization request message may comply with ISO 8583, which is a standard for systems that exchange electronic transactions made by users using payment devices. An authorization request message according to other embodiments may comply with other suitable standards. In embodiments of the invention, an authorization request message may include, among other data, a Primary Account Number (PAN) and expiration date associated with a payment device (e.g. credit/debit card) of the user, amount of the transaction (which may be any type and form of a medium of exchange such a money or points), and identification of a merchant (e.g. merchant ID). Typically, an authorization request message is generated by a server computer at a merchant computer (if the transaction is an e-commerce transaction or card-not-present transaction) or a Point of Sale (POS) device (if the transaction is a brick and mortar type transaction or card-present transaction) and is sent to an issuer computer via a payment processing network and an acquirer computer.

The term “authorization response message” may include a message sent as part of an authorization process for a financial transaction. It may be a message that is sent from an issuer to a merchant, in response to an authorization request message, either approving or rejecting an authorization request for a transaction. An authorization response message may comply with ISO 8583, which is a standard for systems that exchange electronic transactions made by users using payment devices. An authorization request message according to other embodiments may comply with other suitable standards. Typically, an authorization request message is generated by a server computer at an issuer computer and is sent to a merchant computer via a payment processing network and an acquirer computer.

The term “transaction” may refer to a transfer of value between two users (e.g. individuals or entities). A transaction may involve the exchange of goods or services for monetary funds between two users. A typical transaction, as contemplated by embodiments of the claimed invention, involves an individual or entity purchasing goods or services from a merchant in exchange for monetary funds.

The term “second account” may refer to an account associated with a secondary user. In some embodiments, the second account may be linked to a first account, such that the second account is granted a portion of the account limit of the first account. Once the relationship between the first account and the second account is terminated, the second account can function independently. In some embodiments, the second account and the first account may be two accounts of the same user. A primary user may choose to sub-divide their own financial account into multiple sub-accounts for different purposes and with different controls and spending parameters. For example, a primary user may desire to have one sub-account for Internet purchases and another sub-account only for purchasing gas. In such an example, the primary user can create a separate sub-account for each purpose.

The term “secondary user” may refer to an individual or entity. In some embodiments, the secondary user is a user who is associated with the second account and whose second account can be linked to a first account of a primary user. The secondary user can conduct financial transactions with merchants using a second payment device associated with the second account. In some embodiments, the secondary user and the primary user are a single individual with a sub-divided financial account with separate control and spending parameters.

The term “payee” may refer to an individual or entity that is to receive monetary funds for a transaction. In typical transactions, the payee is a merchant who has provided goods or services in exchange for monetary funds.

The term “monetary funds” may include any suitable type of value including dollars, Euros, virtual currency, etc.

The term “settlement file” may include a file that is generated and transmitted as part of transaction processing. A typical settlement file is a batch record containing one or more settlement records, where each settlement record contains payment information for authorized financial transactions. Settlement files are sent in order for a merchant to receive funds for the authorized financial transactions. Settlement records within the settlement files are generally for credit card, debit card, or prepaid card transactions. Settlement files may be generated by a merchant computer or merchant access device or any other appropriate computer apparatus. The settlement file may be transmitted through an acquirer computer, to a payment processing network and to an issuer computer. Settlement files are typically submitted for processing after the close of business for a merchant. Settlement files can also be submitted for processing throughout the day or submitted when their value reaches a desired threshold for processing. In some embodiments, settlement files may be a message requesting monetary funds in the amount of a transaction conducted by a user at a merchant.

The term “initiating” may refer to either the first steps taken in order to begin a process or the steps conducted in order to complete a process. For example, “initiating an authorization hold on the first account” can refer to the actual process required to establish the authorization hold on the first account that is conducted by an issuer computer associated with the first account. However, “initiating an authorization hold on the first account” can also refer to the process of sending a message from a payment processing network to the issuer computer with instructions for establishing an authorization hold on the first account.

The term “transfer of funds” may refer to a movement of monetary funds from one account to another. In some embodiments, transfer of funds is part of a process in a financial transaction system where monetary funds are transferred from an account of a user to an account for a merchant. The transfer of funds may be for the settlement of a previously conducted transaction for goods or services conducted between the user and the merchant. In embodiments of the invention, the transfer of funds is conducted in a clearing and settlement process where monetary funds are electronically debited from a first account at an issuer computer and transmitted through a payment processing network to an acquirer computer associated with a merchant account, where the funds are then electronically credited to the merchant account.

The term “first account” may refer to an account associated with a primary user. In some embodiments, the first account may be linked to a second account, such that the second account is granted a portion of the account limit of the primary account. In some embodiments, the second account and the first account may be two accounts of the same user. A primary user may choose to sub-divide their own financial account into multiple sub-accounts for different purposes and with different controls and spending parameters. For example, a primary user may desire to have one sub-account for Internet purchases and another sub-account only for purchasing gas. In such an example, the primary user can create a separate sub-account for each purpose.

The term “primary user” may refer to an individual or entity. The primary user may be a user who is associated with the first account and whose first account can be linked to (and unlinked from) a second account of a secondary user. The primary user can conduct transactions using a first payment device associated with the first account. The primary user can also utilize a first client computer in order to interact with an account configuration server computer in order to enroll the second account of a secondary user into a linked relationship with the first account. In some embodiments, the secondary user and the primary user are a single individual with a sub-divided financial account with separate control and spending parameters.

The term “configuration data” may refer to data to configure and customize settings. Configuration data may include data that is input by a primary user at a client computer in communication with an account configuration server computer. The configuration data may be stored by the account configuration server computer and transmitted to a payment processing network for storage and for transaction processing (e.g. authorization, clearing and settlement, etc.).

The term “predetermined amount” may refer to an amount of funds established by a primary user for use by a secondary user. In some embodiments, the predetermined amount can be an amount of the credit limit of the first account to be granted to a linked second account. The predetermined amount can either be a set monetary amount or a percentage of the total credit limit of the first account. In some embodiments, the predetermined amount can be a percentage of the current open-to-buy limit of the first account. In embodiments, the predetermined amount is less than the credit limit imposed on the first account by the issuing bank. In other embodiments, the predetermined amount is less than 10%, 20%, 30%, 40%, 50% (or any other suitable percentage) of the credit limit imposed on the first account by the issuing bank.

The term “account limit” may refer to the maximum amount of outstanding balance a user is allowed to place on their financial account (e.g. credit card, debit card, prepaid card, etc.). The maximum amount of outstanding balance a user is authorized to carry on their credit card may be established by the issuer of the financial account. For example, if an issuer has established an account limit of $100 on a user account, the user may conduct one or more transactions totaling less than $100. If the user attempts to conduct a transaction greater than $100, or conducts a plurality of transactions that aggregate to an amount greater than $100, transactions against the user account will be rejected. In embodiments of the invention, the account limit of a secondary user's account may be increased by linking the secondary user's account to a primary user's account, where the primary user grants a portion of the account limit of the primary user's account to the secondary user's account.

The term “authorization hold” may refer to a practice within the banking industry of authorizing electronic transactions conducted with a payment device (e.g. debit card or credit card) and holding a balance as unavailable until a merchant clears the transaction, or the hold period expires. In some embodiments, an authorization hold is a hold placed against a first account. The authorization hold is established based on input configuration data from a primary user interacting with an account configuration server computer. The authorization hold is placed against the first account in the amount of the primary account's credit limit granted to a second account. For example, if the primary user input configuration data indicating a grant of $100 of the credit limit of the first account to the second account, an authorization hold for $100 may be placed against the credit of the first account. In embodiments, the authorization hold is just a hold against the first account and is not treated as being used by the primary user (or secondary user) in any transaction. Thus, while the authorization hold reduces the open-to-buy available to the primary user, it is not subject to interest charges. In some embodiments of the claimed invention, the authorization hold is good for a pre-determined period.

The term “sweep” may refer to a step in a clearing and settlement process. In some embodiments, sweep may refer to the process of pulling transaction data for transactions conducted by the second account. For example, for linked accounts where an authorization hold was established for a 30-day period, transactions may be conducted against the second account for 30 days. After 30 days, all the transactions conducted against the second account may be collected (or swept up) to the first account for the actual transfer of funds to pay for the transactions. Sweeps can be conducted on a pre-determined schedule determined by the primary user, secondary user, issuers, or any other individual or entity that has controls on the second account. In some embodiments, the frequency of transaction sweeps from the second account to the first account may not exceed the amount of time established for a pre-authorization hold against the first account.

The term “severance data” may refer to data related to severing a link. In some embodiments, severance data refers to data that is input by a primary user at a client computer in communication with an account configuration server computer. The severance data is input to indicate that the primary user wants to terminate or server the link between a primary (or first) account and a secondary (or second) account. The severance data is stored by the account configuration server computer and transmitted to a payment processing network for storage and for severing the link between the first and second accounts.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

The term “payment processing network” may include a network of suitable processing entities (e.g., computers) that can have the ability to route transactions. have information related to an account associated with a payment device such as a debit or credit card.

The payment processing network may have or operate at least a server computer and may include a database. The database may include any hardware, software, firmware, or combination of the preceding for storing and facilitating retrieval of information. In addition, the database may use any of a variety of data structures, arrangements, and compilations to store and facilitate retrieval of information. The server computer may be coupled to the database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

The payment processing network may include data processing subsystems, networks, and operations used to support and deliver authorization services, exception file services, and clearing and settlement services. An exemplary payment processing network may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. Payment processing network may use any suitable wired or wireless network, including the Internet.

### I. Systems

Example embodiments are typically implemented in the context of a financial transaction. Therefore, prior to further discussing creating new merchant profiles and automatically populating new and existing merchant profiles with fraud detection rules within a fraud detection system, a brief description of transaction processing will be presented.

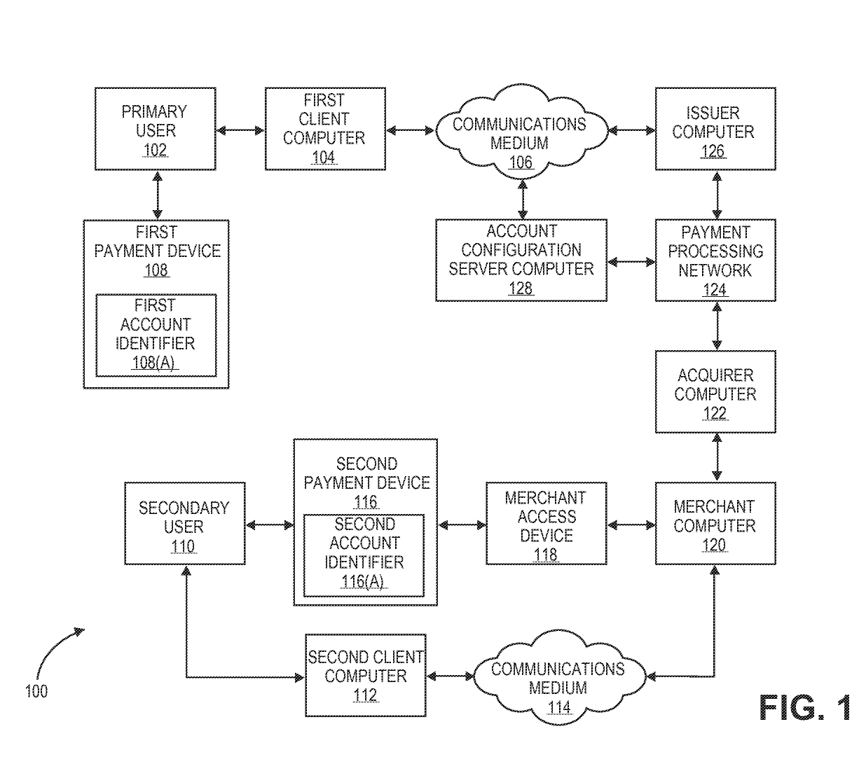

An exemplary system 100 for transaction processing can be seen in FIG. 1. The system 100 includes a primary user 102, a first client computer 104, a communications medium 106, a first payment device 108, a secondary user 110, a second client computer 112, a communications medium 114, and a second payment device 116. In embodiments, the first payment device 108 and the second payment device 116 comprise a first account identifier 108(A), and a second account identifier 116(A), respectively. Such account identifiers may be stored in computer readable media in the first and second payment devices. The system 100 may also include a merchant access device 118, a merchant computer 120, an acquirer computer 122, a payment processing network 124, an issuer computer 126, and an account configuration server computer 128.

The primary user 102 may be an individual, or an organization such as a business, that is capable of purchasing goods or services. The secondary user 110 may also be an individual, or an organization such as a business, that is capable of purchasing goods or services. The secondary user 110 may further be in a relationship with the primary user 102, such that the secondary payment device 116 and an associated secondary account of the secondary user 110 is linked to a primary account of the primary user 102. Exemplary relationships can include: employer-employee, parent-child, and parent-caregiver.

The primary account can be an example of a first account and a secondary account can be an example of a second account. In embodiments of the invention, the first account identifier 108(A) and the second account identifier 116(A) may be a primary account number and a secondary account number, respectively.

In a typical transaction, the secondary user 102 may purchase goods or services at a merchant associated with the merchant computer 120 using a second payment device 116. The secondary user 102 may also purchase goods using the second payment device 116 at a merchant access device 118 (e.g. a POS terminal) operatively connected to the merchant computer 120. The transactions details are then sent to the acquirer computer 122. The acquirer computer 122 can communicate with an issuer computer 126 via a payment processing network 124 for additional transaction processing. For simplicity of illustration, a certain number of components are shown is shown in FIG. 1. It is understood, however, that embodiments of the invention may include more than one of each component. In addition, some embodiments of the invention may include fewer than all of the components shown in FIG. 1. In addition, the components in FIG. 1 may communicate via any suitable communication medium (including the Internet), using any suitable communication protocol.

The first payment device 108 may be in any suitable form. For example, suitable first payment devices can be hand-held and compact so that it can fit into a user's wallet and/or pocket (e.g., pocket-sized). The first payment device 108 can include a processor, and memory, input devices, and output devices, operatively coupled to the processor. Specific examples of first payment devices include cellular or wireless phones, personal digital assistants (PDAs), pagers, portable computers, smart cards, and the like. The first payment devices can also be debit devices (e.g., a debit card), credit devices (e.g., a credit card), or stored value devices (e.g., a pre-paid or stored value card). The first payment device 108 may comprise a first account identifier 108(A) indicating an associated primary account. The second payment device 116 may be in any suitable form as the first payment device 108 and may comprise a second account identifier 116(A) indicating an associated secondary account. In some embodiments, the primary account is associated with a credit card and the secondary account is associated with a debit card or prepaid card.

The first client computer 104 may communicate with the issuer computer 126 via the communications medium 106, such as a network (e.g. the Internet). The first client computer 104 may communicate with the account configuration server computer 128 via the communications medium 106. Similarly, the second client computer 112 may communicate with the merchant computer 120 via the communications medium 114, such as a network (e.g. the Internet). The first client computer 104 may be in any suitable form. Examples of client computers include any device capable of accessing the Internet, such as a personal computer, cellular or wireless phones, personal digital assistants (PDAs), tablet PCs, and handheld specialized readers. In some embodiments of the invention, the first payment device 108 and the first client computer 104 can be a single device.

The secondary user 110 can use the second client computer 112, which is communicatively coupled to the merchant computer 120 via the communications medium 114 in order to conduct a transaction with the merchant associated with the merchant computer 120. The second client computer 112 may be in any suitable form. Examples of client computers include any device capable of accessing the Internet, such as a personal computer, cellular or wireless phones, personal digital assistants (PDAs), tablet PCs, and handheld specialized readers. The second client computer 112 can transmits data through the communications medium 114 to the merchant computer 120. In some embodiments of the invention, the second payment device 116 and the second client computer 112 can be a single device. It is also understood that payment devices may or may not be used in embodiments of the invention. For example, the primary and secondary accounts may be virtual accounts that do not have corresponding payment devices.

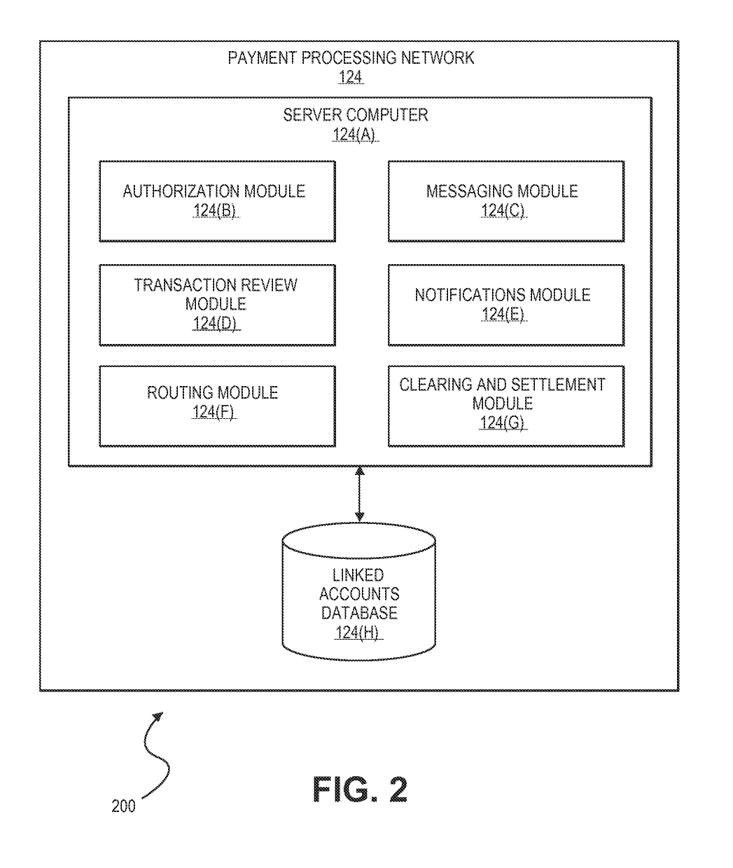

As depicted in FIG. 2, the payment processing network 124 may comprise a server computer 124(A) comprising an authorization module 124(B), a messaging module 124(C), a transaction review module 124(D), a notifications module 124(E), a routing module 124(F), and a clearing and settlement module 124(G). The various modules may be embodied by computer code, residing on computer readable media.

As noted above, the payment processing network 124 may have or operate at least a server computer 124(A). In some embodiments, the server computer 124(A) may be coupled to a database and may include any hardware, software, other logic, or combination of the preceding for servicing the requests from one or more client computers. The one or more databases may comprise a linked accounts database 124(H). The server computer 124(A) may comprise one or more computational apparatuses and may use any of a variety of computing structures, arrangements, and compilations for servicing the requests from one or more client computers.

The payment processing network 124 may include data processing subsystems, networks, and operations used to support and deliver authorization services, exception file services, and clearing and settlement services. An exemplary payment processing network may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The payment processing network 124 may use any suitable wired or wireless network, including the Internet.

The authorization module 124(B) may process authorization request messages and determine the appropriate destination for the authorization request messages.

An authorization request message is a message sent requesting that an issuer computer 126 authorize a financial transaction. An authorization request message may comply with ISO 8583, which is a standard for systems that exchange electronic transactions made by users using payment devices. An authorization request message according to other embodiments may comply with other suitable standards. In embodiments of the invention, an authorization request message may include, among other data, a Primary Account Number (PAN) and expiration date associated with a payment device (e.g. credit/debit card) of the user, amount of the transaction (which may be any type and form of a medium of exchange such a money or points), category identification of a merchant (e.g. merchant ID), and a second account identifier 116(A). In embodiments, an authorization request message is generated by a server computer (if the transaction is an e-commerce transaction) or a Point of Sale (POS) device (if the transaction is a brick and mortar type transaction) and is sent to an issuer computer 126 via the payment processing network 124 and the acquirer computer 122.

An authorization response message is a message sent from the issuer computer 126, in response to an authorization request message either to approve or decline a financial transaction. An authorization response message may comply with ISO 8583, which is a standard for systems that exchange electronic transactions made by users using payment devices.

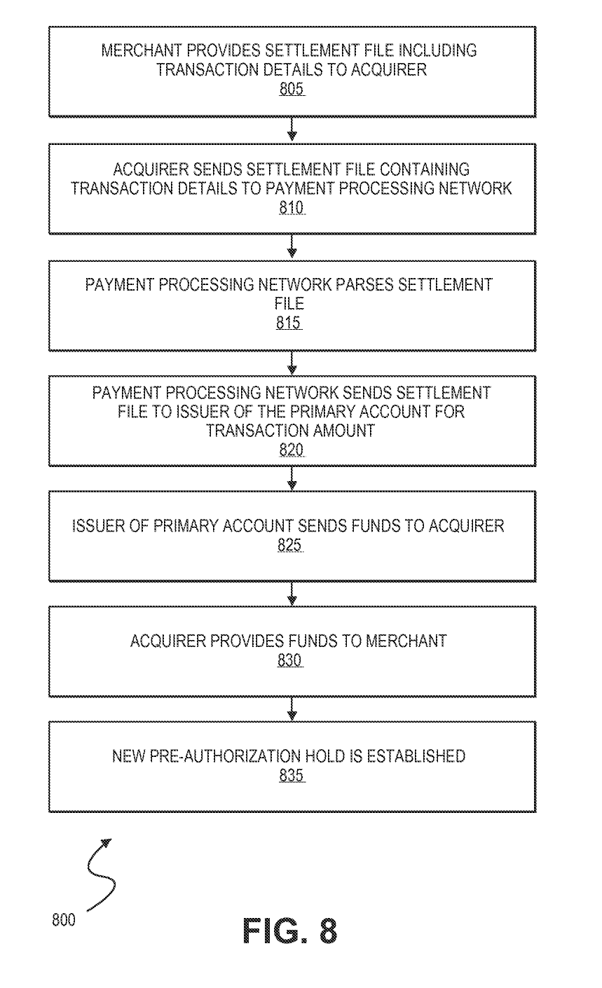

The clearing and settlement module 124(G) may handle the clearing and settlement of transactions. The clearing and settlement module 124(G) authenticates user information and organizes the settlement process of user accounts between the acquirer computer 122 and the issuer computer 126. An example of the clearing and settlement module 124(G) is the Base II data processing system, which provides clearing, settlement, and other interchange-related services. Additional details regarding the clearing and settlement process will be discussed with respect to FIG. 8.

The messaging module 124(C) may send and receive authorization request messages and authorization response messages. The messaging module 124(C) may receive authorization request messages from and send authorization response messages to the acquirer computer 122, as well as send authorization request messages to and receive authorization response messages from the issuer computer 126. The messaging module 124(C) may further receive configuration data from the account configuration server computer 128, comprising data for establishing a link between a primary account and a secondary account. The configuration data may then be stored in the linked accounts database 124(H) for later transaction processing.

The transaction review module 124(D) may process transactions that are received by the payment processing network 124. The transaction review module 124(F) can evaluate each received authorization request messages and determine whether the second account identifier 116(A) contained in the authorization request message is contained in the linked accounts database 124(H). Where the second account identifier is contained in the linked accounts database 124(H), the transaction review module 124(D) can determine whether the second payment device 116 has an active link to a primary user account. The transaction review module 124(D) may further evaluate transaction details contained in financial messages in order to route authorization request messages and settlement messages or files to the appropriate issuer computer 126.

The notifications module 124(E) may be configured to send notifications and alerts. In embodiments of the claimed invention, when the secondary user 110 conducts a transaction with a linked secondary account or second payment device 116, the notifications module 124(E) may send an alert message to the primary user 102 indicating that the linked secondary account or second payment device 116 has been used. The alert messages can be sent in real-time as the transaction is occurring or can be sent after transaction processing has been completed. The alert message can be in any suitable format. Examples of alert messages can include SMS messages, electronic mail messages, standard postal mail messages, or in any other suitable message format. In some embodiments of the claimed invention, alert messages are sent to the primary user 102 regardless of whether the transaction conducted by the secondary user 110 with the linked secondary account or second payment device 116 was approved or rejected. In some embodiments, the alert message are sent in real-time to inform the primary user 102 that the credit limit of the linked secondary account or second payment device 116 is close to or will exceed a threshold amount with the current transactions. In such embodiments, the alert message can include a request for approval of the transaction despite the credit limit being exceeded, and the primary user 102 can choose to authorize or reject a one-off funding transaction.

The routing module 124(F) may handle the routing of authorization request messages from the acquirer computer 122 to the issuer computer 126, and routing the authorization response messages back from the issuer computer 126 to the acquirer computer 122. The routing module 124(F) may further handle the routing of clearing and settlement messages or files between the acquirer computer 122 and the issuer computer 126 related to the clearing and settlement process.

Referring to FIG. 1, the merchant computer 120 may be comprised of various modules that may be embodied by computer code, residing on computer readable media. It may include any suitable computational apparatus operated by a merchant. Examples of merchant computers may include an access device or an internet merchant computer. The merchant computer 120 may be in any suitable form. Additional examples of merchant computers include any device capable of accessing the Internet, such as a personal computer, cellular or wireless phones, personal digital assistants (PDAs), tablet PCs, and handheld specialized readers. The merchant computer 120 transmits data through the communications medium 114 to the second client computer 112. The merchant computer 120 may also receive and transmit data to the merchant access device 118. In embodiments of the invention, the merchant computer 110 receives transaction data from the second client computer 112 or the merchant access device 118 and transmits the transaction data to the payment processing network 124 for further transaction authorization processes.

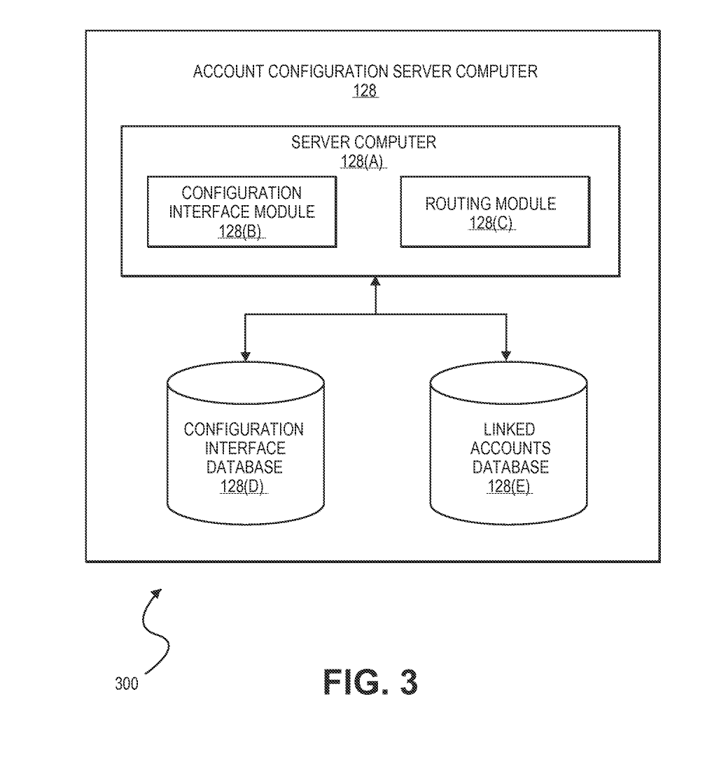

As depicted in FIG. 3, the account configuration server computer 128 may comprise a server computer 128(A) comprising a configuration interface module 128(B), and a routing module 128(C). The various modules may be embodied by computer code, residing on computer readable media.

As noted, the account configuration server computer 128 may have or operate at least a server computer 128(A). In some embodiments, the server computer 128(A) may be coupled to a database and may include any hardware, software, other logic, or combination of the preceding for servicing the requests from one or more client computers. The one or more databases may comprise a configuration interface database 128(D) and a linked accounts database 128(E). The server computer 128(A) may comprise one or more computational apparatuses and may use any of a variety of computing structures, arrangements, and compilations for servicing the requests from one or more client computers.

The configuration interface database 128(D) may store the website data used to generate the configuration interface 400 that can be accessed by the primary user 102. The linked accounts database 128(E) may be used by the account configuration server computer 128 to store the configuration data input by the primary user 102 through the configuration interface 400.

The configuration interface module 128(B) may access website data stored in the configuration interface database 128(D) to generate a configuration interface 400. The first client computer 108 may by used the primary user 102 to access the configuration interface 400 hosted by the configuration interface module 128(B).

The routing module 128(C) can route configuration data to the appropriate destination. Once the configuration data has been input by the primary user 102, the routing module 128(C) can route the configuration data to the payment processing network 124 for further processing and for storage.

Referring again to FIG. 1, an acquirer computer 122 is typically a system for an entity (e.g. a bank) that has a business relationship with a particular merchant or other entity. An issuer computer 126 is typically a business entity (e.g. a bank) which maintains financial accounts for the primary user 102 and secondary user 110 and can issue a first payment device 108 and a second payment device 116 such as a credit or debit card to the primary user 102 and secondary user 110, respectively. Some entities can perform both issuer computer 126 and acquirer computer 122 functions. Embodiments of the invention encompass such single entity issuer-acquirers.

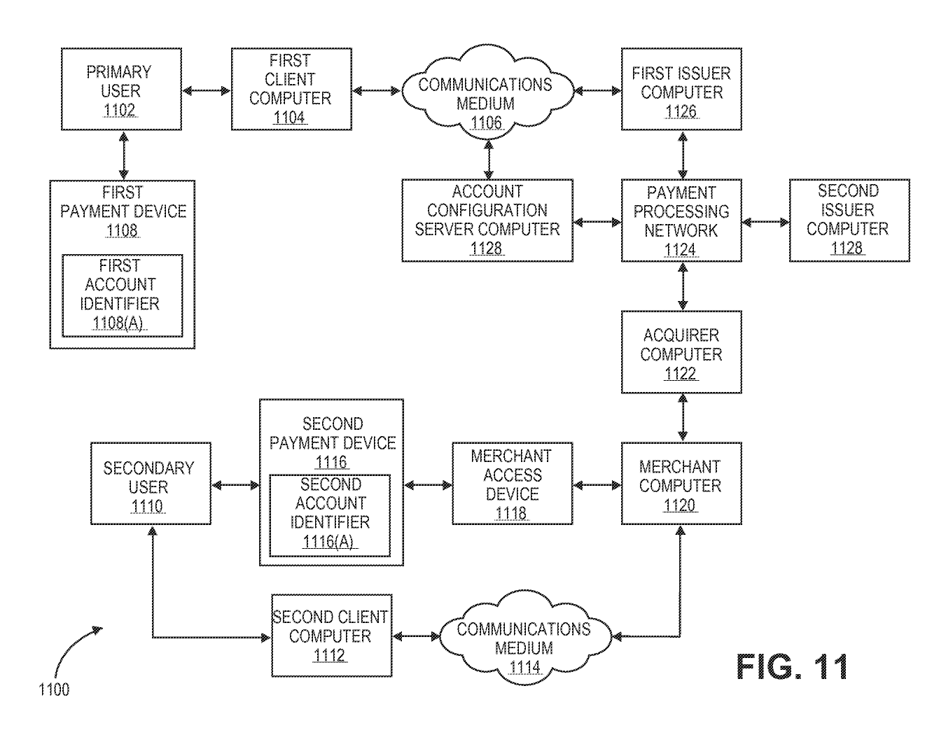

FIG. 11 depicts another system 1100 for transaction processing where the primary user 1102 has a primary account associated with a first issuer computer 1126, and the secondary user 1110 has a secondary account associated with a second issuer computer 1128. The system 1100 includes the primary user 1102, a first client computer 1104, a communications medium 1106, a first payment device 1108, the secondary user 1110, a second client computer 1112, a communications medium 1114, and a second payment device 1116. In embodiments, the first payment device 1108 and the second payment device 1116 comprise a first account identifier 1108(A), and a second account identifier 1116(A), respectively. The system 1100 may also include a merchant access device 1118, a merchant computer 1120, an acquirer computer 1122, a payment processing network 1124, the first issuer computer 1126, the second issuer computer 1128, and an account configuration server computer 1130. The components of the system depicted in FIG. 11 may be similar to those described with respect to FIG. 1.

In the embodiment depicted in FIG. 11, the primary user 1102, first payment device 1108, and a primary account can be associated with the first issuer computer 1126, while the secondary user 1110, second payment device 1116, and a secondary account can be associated with the second issuer computer 1128.

The first issuer computer 1126 is typically a business entity (e.g. a bank) which maintains financial accounts for the primary user 1102 and secondary user 1110 and can issue a first payment device 1108 and a second payment device 1116 such as a credit or debit card to the primary user 1102 and secondary user 1110, respectively. The components of the second issuer computer 1128 may be similar to those described with respect to the first issuer computer 1126.

In the multiple issuer computer system, as depicted in FIG. 11, the first issuer computer 1126 and the second issuer computer 1128 may utilize the same or different messaging systems. However, the payment processing network 1124, to which both the first issuer computer 1126 and the second issuer computer 1128 are operably connected to, may facilitate communication and settlement between the two issuer computers using a single messaging format for communications and transmissions to and from the first issuer computer 1126 and the second issuer computer 1128. Using a standard message format for transactions and settlement processes allows for the payment processing network 1124 to create arrangements for linked accounts where the primary account and secondary account are issued by different bank entities. This allows a second issuer of a secondary account to form a linked relationship with a first issuer of a primary account. For example, standard Single Messaging System (SMS) or Base I/II messaging may be used for the account linking process and the clearing and settlement process.

In the systems depicted in FIGS. 1 and 11, standard messaging formats can be used. For example, ISO 8583 messaging is a standard for systems that exchange electronic transactions made by users using payment devices (e.g. payment cards).

In a single issuer system as depicted in FIG. 1, as there is no actual transfer of funds until the clearing and settlement process, exemplary message type indicators using a Single Message System (SMS) can include: “0100” (request for authorization, such as the pre-authorization hold) and “0110” (issuer computer 126 response for authorization).

In a dual issuer system as depicted in FIG. 11, where there is an actual transfer of funds from the first issuer computer 1126 to the second issuer computer 1128, exemplary message type indicators using SMS can include: “0200” (request for funds), “0210” (issuer computer 1126 response to request for funds); and “0220” (used to complete a transaction initiated with the authorization request).

### II. Methods

Methods according to embodiments of the invention can be described with respect to FIGS. 1-10.

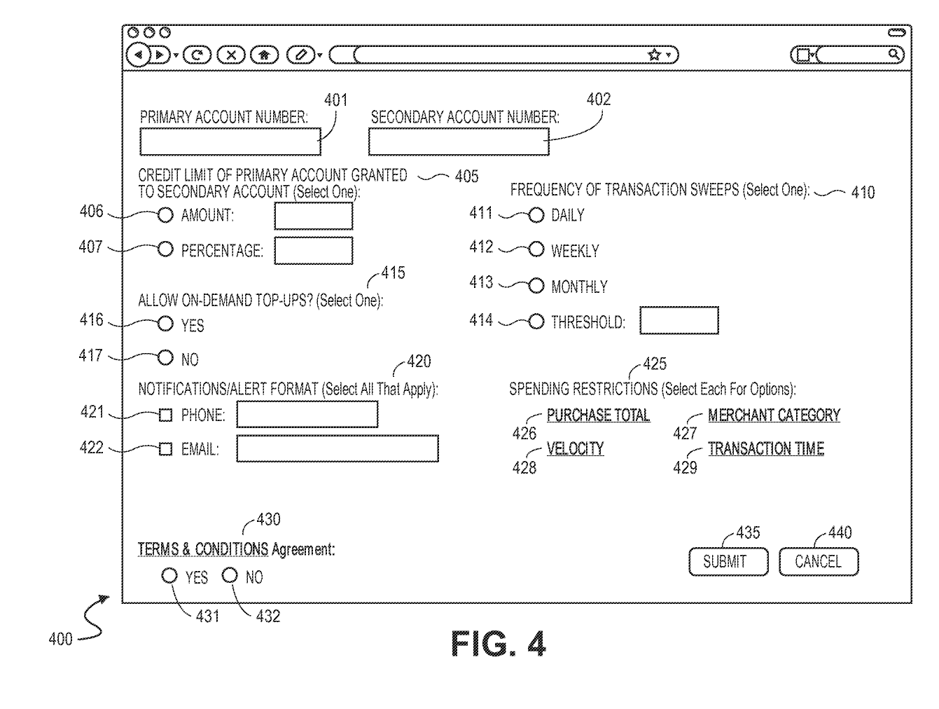

FIG. 4 depicts an exemplary configuration interface 400 that can be accessed on an account configuration server computer 128 by a primary user 102 using a first client computer 104. The configuration interface 400 can be on a website hosted on the account configuration server computer 128. In some embodiments of the invention, the configuration interface 400 can be hosted on an issuer computer 126 or on a payment processing network 124. The configuration interface 400 can also be accessed via a mobile application using any appropriate first client computer 104 capable of accessing mobile applications.

The exemplary configuration interface 400 shown in FIG. 4 includes customizable settings and a plurality of fields that the primary user 102 may complete in order to initiate a linking process. Other embodiments of the configuration interface 400 may include the options shown in FIG. 4, additional options, or fewer options. A primary account number field 401 and a secondary account number field 402 allow the primary user 102 to enter the account numbers for the primary account and the secondary account desired to be linked.

The primary user 102 can specify a portion of a credit limit of the primary account that the primary user 102 chooses to grant to the secondary account in setting section 405. The primary user 102 can select the button corresponding to how the primary user 102 chooses to have the credit limit granted. The primary user 102 can select the “Amount” button 406 and fill in the corresponding text box with the specified monetary amount. Alternatively, the primary user 102 can select the “Percentage” button 407 and fill in the corresponding text box with a percentage of the primary account's credit limit to be granted to the secondary account 110.

The primary user 102 can also establish a frequency for sweeping up transactions from the secondary account with the “Frequency of Transaction Sweeps” setting 410. The primary user 102 can select the button corresponding to how frequently the primary user 102 chooses to sweep the transactions up from the secondary account. The primary user 102 can select the “Daily” button 411, the “Weekly” button 412, the “Monthly” button 413, or the “Threshold” button 414. If the primary user 102 selects the “Threshold” button 414, the primary user 102 may fill in the corresponding text box with a monetary amount. As the secondary user 110 uses the credit limit granted by the primary user 102, when the amount available drops below the set “Threshold” value, the transactions will be swept-up to the primary account. In other embodiments, the primary user 102 may specify a specific number of days before transactions are swept from the secondary account.

The primary user 102 can also choose to allow or disallow on-demand top-ups 415, by selecting the “Yes” button 416 or the “No” button 417. In embodiments, if the primary user 102 allows on-demand top-ups, the primary user 102 may receive a notification that the credit limit granted to the secondary account will be exceeded with a current transaction, and the primary user 102 may be given the option to approve or deny a one-time increase in the credit limit in order to cover the cost of the current transaction. The notification can be sent by any appropriate messaging means (e.g. SMS messaging, automated phone call, electronic mail, etc.).

The primary user 102 can customize notification or alert settings 420. The primary user 102 can select the checkboxes for the methods of notifications that the primary user 102 chooses to receive. The primary user 102 can select the “Phone” checkbox 421, and fill in the corresponding text box with a phone number, and/or select the “Email” checkbox 422, and fill in the corresponding text box with an email address. Alerts in embodiments of the invention can include e-mails, text messages, automated phone calls, and other forms of notifications.

The primary user 102 can further establish spending restrictions on transactions conducted using the secondary account by selecting optional spending restrictions 425. Selecting the optional spending restrictions brings the primary user 102 to another page with settings for the corresponding optional spending restrictions. In some embodiments, selecting one of the optional spending restrictions causes a pop-up box with settings to appear on the configuration interface 400. Optional spending restrictions may include “Purchase Total” 426, “Merchant Category” 427, “Velocity” 428, and “Transaction Time” 429. In some embodiments, spending can also be restricted based on geographic data (e.g. merchant address, merchant country, etc.). Spending could be restricted to merchants located within particular zip codes, particular states or particular countries. For example, the primary user 102 can establish that the open-to-buy limit or credit limit granted to the secondary account may only be used in the state of California. Additional spending restrictions may include options to allow or disallow transactions conducted over the Internet (e.g. card not present transactions). For example, only in-person transactions may be allowed for use of the granted open-to-buy limit or credit limit.

Embodiments of the invention can include additional account parameters, including, but not limited to: expiration date (e.g. length of time for the linked relationship to be in force), PIN-enablement, nickname for secondary account, etc. Other embodiments provide for pre-defined profiles to be created and selected. For example, a “caregiver” profile may allow transactions at grocery stores and convenience stores, but disallow transactions at gambling establishments.

The primary user may also have to review and accept a hyperlinked Terms & Conditions Agreement 430, by selecting a “Yes” button 431 or a “No” button 432.

Once the primary user 102 has completed the fields and settings on the configuration interface 400, the primary user 102 can submit the enrollment data for processing by selecting the “Submit” button 435. The primary user 102 can also cancel the enrollment by selecting the “Cancel” button 440.

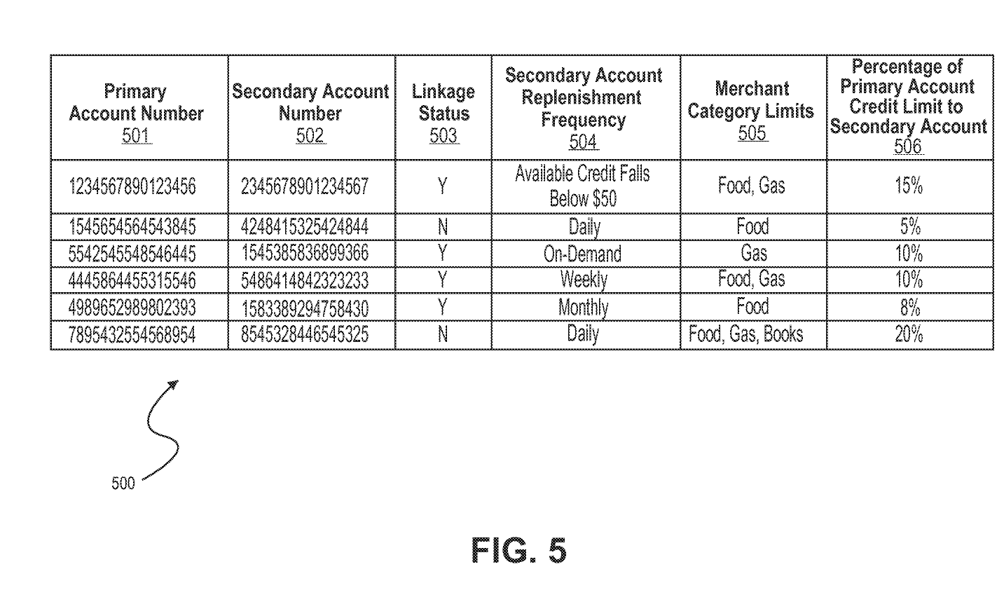

FIG. 5 depicts an exemplary data table 500 that can be stored in a database at and accessed by the payment processing network 124. The data table 500 may contain data regarding the status and settings of linked primary and secondary accounts. Optional fields in the data table 500 can include, but are not limited to primary account number 501, secondary account number 502, linkage status 503, secondary account replenishment frequency 504, merchant category limits 505, and the percentage of the primary account credit limit granted to the secondary account 506. Embodiments of the claimed invention can include all of these fields shown in FIG. 5, additional fields, or fewer fields. For example, additional embodiments may include additional fields for additional spending restrictions.

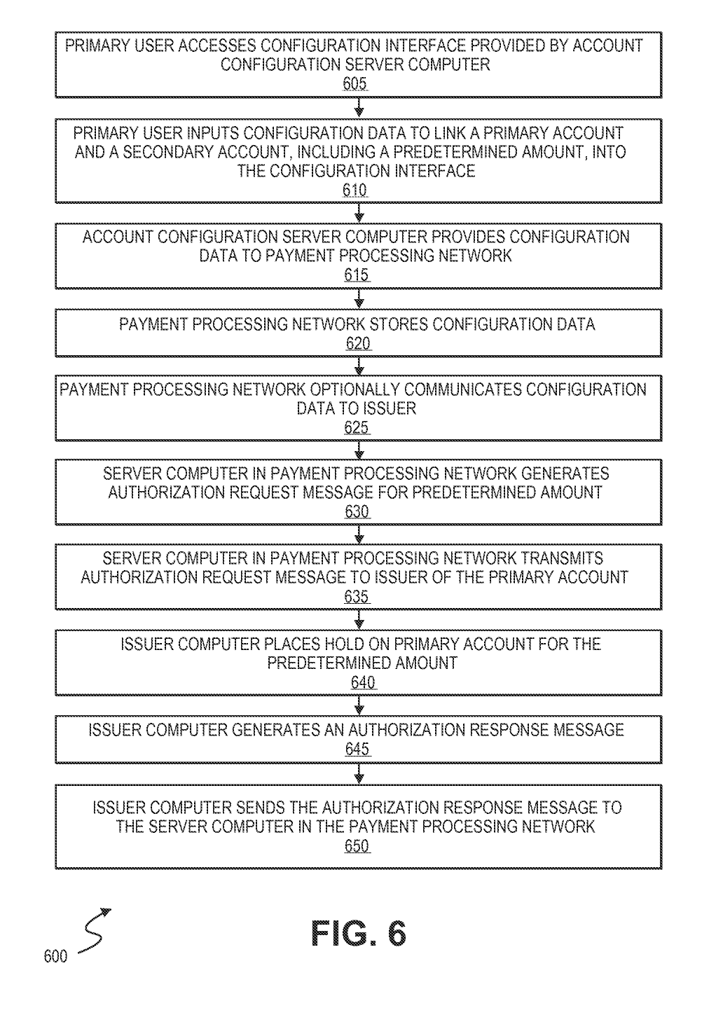

FIG. 6 is a flowchart of a method 600 for enrolling a secondary account into a linked relationship with a primary account and setting up the secondary account for payment transactions using a system 100 shown in FIG. 1.

The messaging format for establishing the funding of the secondary account and placing the hold on the primary account can be accomplished using different messaging systems. For example, a Single Message System (SMS), a form of electronic message, may be used and allows for both authorization and capture of funds in a single message. Other exemplary messaging systems include Base I and Base II. Base I is an electronic message that notifies an issuer to authorize and hold pending a future file with transaction details. Base II is a file that can be sent to an issuer computer with actual transaction details that may be used to settle the hold contained in the previously sent Base I message. In embodiments, a Base I message may be sent from the payment processing network 124 to the issuer computer 126 requesting a pre-authorization hold be placed against the primary account for a predetermined amount. Later, during a clearing and settlement process, a Base II file can be sent from the payment processing network 124 to the issuer computer 126 with the transaction details for clearing and settlement against the primary account. For example, a Base II settlement file with a “05” file indicator indicates that the file is for a transaction. If a Base II settlement file is not received by the issuer computer 126, the hold may drop off after a pre-established expiration period.

In step 605, the primary user 102 accesses a configuration interface 400 provided by an account configuration server computer 128. The primary user can access the configuration interface 400 on a first client computer 104 through a communications medium 106, such as the Internet. In some embodiments, the configuration interface 400 can be a hosted website with fields and options that allow the primary user 102 to customize enrollment and usage settings. In some embodiments, the configuration interface 400 may be hosted by a payment processing network 124 or an issuer computer 126. A configuration interface module 128(B) can access a configuration interface database 128(D) in order to retrieve and present the hosted website for display on the first client computer 104.

In step 610, the primary user 102 inputs configuration data to link a primary account and a secondary account of a secondary user 110 into the configuration interface 400. The configuration data may also include a predetermined amount of the credit limit of the primary account to grant to the secondary account for usage. In some embodiments, the primary user 102 inputs the account numbers for a primary account and a secondary account, where the secondary account is to be linked to the first account and granted a portion of the primary account's open-to-buy or credit limit. The predetermined amount can be a set monetary amount or a percentage of the credit limit of the primary account. For example, the primary user 102 may choose to grant $100 of the open-to-buy or credit limit of the primary account to the secondary account. The configuration data can further comprise data regarding the frequency of top-ups, spending restrictions, and notification/alert settings.

In step 615, the account configuration server computer 128 provides configuration data to payment processing network 124. The account configuration server computer 128 comprises a routing module 128(C) that can transmit the configuration data to the payment processing network 124. In some embodiments, the configuration data is received by a messaging module 124(C) contained in a server computer 124(A) in the payment processing network 124. The payment processing network 124 receives the configuration data to link the primary (or first) account to the secondary (or second) account, indicating an allocation of a predetermined amount of an account limit (or credit limit) of the secondary account granted by the primary account.

In step 620, the payment processing network 124 stores the configuration data. In embodiments of the claimed invention, the configuration data is stored in a linked accounts database 124(H). The configuration data can be stored in a data table as depicted in FIG. 5 and may contain all the account details for the primary and secondary accounts that are required for processing financial transactions.

In step 625, the payment processing network 124 optionally communicates configuration data to the issuer. In embodiments of the invention, the payment processing network 124 can further send the configuration data received from the account configuration server computer 128 to the issuer computer 126 by any appropriate messaging means. The issuer computer 126 receives the configuration data to link the primary (or first) account to the secondary (or second) account, indicating an allocation of a predetermined amount of an account limit (or credit limit) of the secondary account granted by the primary account.

In step 630, the server computer 124(A) in the payment processing network 124 generates an authorization request message for the predetermined amount of the credit limit of the primary account to grant to the secondary account. In other words, the payment processing network 124 initiates an authorization hold on the primary account for the predetermined amount by generating the authorization request message for the predetermined amount. The authorization request message can also contain the designated hold period for the predetermined amount. For example, the authorization request message may indicate a predetermined amount of $100 to be granted to the secondary account for a pre-authorization hold period of one month. In other words, the secondary account will be granted access to $100 of the credit limit of the primary account for one month.

In step 635, the server computer 124(A) in the payment processing network 124 transmits the authorization request message to the issuer of the primary account and the secondary account. The payment processing network 124 transmits the authorization request message via a messaging module 124(C) contained in the server computer 124(A). The destination of the authorization request message is determined based on the content of the authorization request message indicating the appropriate issuer computer 126. The routing module 124(F) determines the appropriate issuer computer 126 to which the authorization request message is to be transmitted by the messaging module 124(C). The authorization request message may be sent using any appropriate messaging means.

In step 640, issuer computer 126 places hold on the primary account for the predetermined amount. Once the issuer computer 126 receives the authorization request message, the issuer computer 126 parses the authorization request message for at least the primary account number and secondary account number, the predetermined amount, and the designated hold period. The issuer computer 126 initiates an authorization hold on the primary account for the predetermined amount and for the designated hold period. The issuer computer 126 also increases the open-to-buy limit of the secondary account by the predetermined amount. For example, if the predetermined amount was for $100 and the frequency for transaction sweeps was monthly, a pre-authorization hold of $100 would be placed on the open-to-buy limit of the primary account, and a unique pre-authorization hold ID for the hold would be generated (e.g. Pre-authorization Hold ID: 56789010). In embodiments, the amount of time the pre-authorization hold is valid matches the frequency for transaction sweeps designated by the primary user 102. The issuer computer 126 then increases the open-to-buy limit of the secondary account by $100 and tags the secondary account with the unique pre-authorization hold ID (e.g. Pre-authorization Hold ID: 56789010).

In step 645, issuer computer 126 generates an authorization response message. The authorization response message can contain an approval or denial of the hold request contained in the authorization request message. In embodiments, the pre-authorization hold ID is also sent to the payment processing network 124 for storage and for use in the clearing and settlement process.

In step 650, issuer computer 126 sends the authorization response message to the server computer 124(A) in the payment processing network 124. The payment processing network 124 can update the linkage status of the primary account and the secondary account by updating the Linkage Status field corresponding to the primary account and secondary account in the data table shown in FIG. 5.

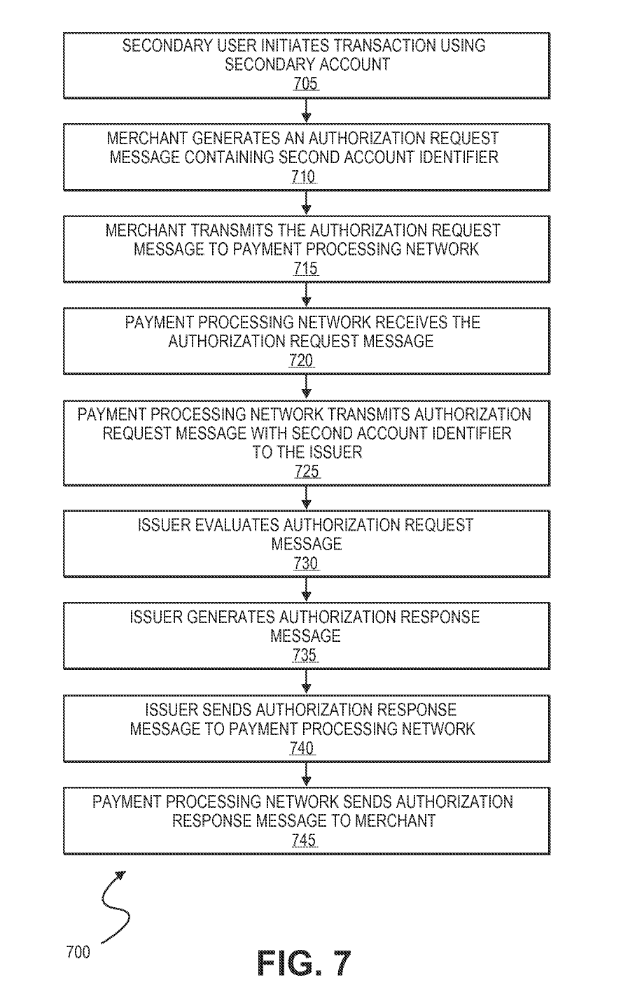

FIG. 7 is a flowchart of a method 700 for conducting a financial transaction using a secondary account in a linked relationship with a primary account using a system 100 shown in FIG. 1.

In step 705, a secondary user 110 initiates a transaction using a secondary account. In a typical transaction, the secondary user 110 engages in a transaction for goods or services at a merchant associated with a merchant computer 120 using a second client computer 112 and a second payment device 116 such as a credit card or mobile phone. For example, the secondary user 110 may use their Internet-enabled mobile phone to access a merchant website to conduct a transaction using their second payment device 116. In other embodiments, the secondary user 110 may swipe the credit card through a merchant access device 118 (e.g. POS terminal) or, in another embodiment, may take a wireless phone and may pass it near a contactless reader in a POS terminal.

In step 710, the merchant generates an authorization request message containing a second account identifier 116(A) contained in the second payment device 116. The authorization request message may be generated by either a web server in the merchant computer 120 or by a merchant access device 118 (e.g. a POS terminal). The authorization request message may be generated in any suitable format. Transactions details may be comprised of, but is not limited to, the following: secondary user name, secondary user billing address, secondary user shipping address, secondary user phone number, second account identifier 116(A) (e.g. second account number, etc.), items purchased, item prices, etc.

In step 715, the merchant transmits the authorization request message to payment processing network 124. The authorization request message may be transmitted to the payment processing network 124 by the merchant computer 120 through an acquirer computer 122. The authorization request message may be transmitted in any suitable format.

In step 720, the payment processing network 124 receives the authorization request message. The payment processing network 124 receives the authorization request message requesting authorization to conduct a transaction for a transaction amount using a secondary account of a secondary user 110, where the transaction is being conducted between the secondary user 110 and a payee (e.g. a merchant). A messaging module 124(C) may receive authorization request messages from the acquirer computer 122 and send authorization request messages to the issuer computer 126. A transaction review module 124(D) may parse the authorization request message to determine the appropriate issuer computer 126 to send the authorization request message to.

In step 725, the payment processing network transmits authorization request message with second account identifier to the issuer. After receiving the authorization request message, the payment processing network 124 may then transmit the authorization request message to an appropriate issuer computer 126 associated with the second payment device 116.

In step 730, the issuer evaluates the authorization request message. The issuer computer 126 receives the authorization request message requesting authorization to conduct a transaction for a transaction amount using a secondary account of a secondary user 110, where the transaction is being conducted between the secondary user 110 and a payee (e.g. a merchant). The issuer computer 126 may then determine whether the transaction can be authorized. The issuer computer 126 may evaluate the contents of the authorization request message to determine whether the transaction satisfies the conditions and settings established by the primary user 102 with respect to spending restrictions of the granted credit limit of the primary account. For example, the primary user 102 may have specified that the granted credit limit was only valid for transactions for food or gas. If the transaction details in the authorization request message indicate that the transaction was for the purchase of fruits and bread, the issuer computer 126 may approve the transaction. However, if the transaction details in the authorization request message indicate that the transaction was for the purchase of alcoholic beverages, the issuer computer 126 may decline the transaction.

In some embodiments of the invention, when the transaction is approved, the issuer computer 126 may reduce the pre-authorization hold against the primary account, debit the primary account in the amount of the transaction, and reduce the open-to-buy limit of the secondary account in the amount of the transaction. For example, if the primary user 102 granted $100 to the secondary account, and the amount of the transaction was $25, the issuer computer 126 would reduce the authorization hold against the primary account from $100 to $75, charge $25 against the primary account, and reduce the open-to-buy limit of the secondary account from $100 to $75.

In step 735, the issuer generates an authorization response message. The issuer computer 126 generates the authorization response message and transmits the authorization response message to the payment processing network 124. The authorization response message can indicate whether the transaction contained in authorization request message has been authorized or has been declined by the issuer computer 126.

In step 740, the second issuer sends authorization response message to the payment processing network. The issuer computer 126 can send the authorization response message to the payment processing network 124. The message may be sent by an appropriate messaging means. The payment processing network may debit a ledger balance for the secondary account based the authorization response message. For example, if the $25 purchase was approved, the ledger balance of the secondary account would be reduced from $100 to $75.

In step 745, the payment processing network 124 sends the authorization response message back to the merchant. The payment processing network 124 may send the authorization response message back to the acquirer computer 122, which may then transmit the authorization response message back to the merchant computer 120. The merchant computer 120 may parse the authorization response message. If the transaction was approved, the merchant computer 120 may store the transaction data in a reconciliation file for future clearing and settlement processes. In some embodiments, the reconciliation file is stored at the payment processing network 124.

FIG. 8 is a flowchart of a method 800 of clearing and settling a financial transaction involving a secondary account in a linked relationship with a primary account using a system 100 shown in FIG. 1.

In step 805, the merchant provides the settlement file containing transaction details to the acquirer. The settlement file may contain a reconciliation file containing all the transaction details for transactions conducted between the secondary user 110 and the merchant using the open-to-buy limit or credit limit granted by the primary user 102 to the secondary account of the secondary user 110. The transaction may have been conducted through either the secondary user 110 using a second client computer 112 to access a website hosted by a merchant computer 120 through a communications medium 114, or by the secondary user 110 using a second payment device 116 to interact with a merchant access device 118 (e.g. a POS terminal). In either scenario, the merchant will send a settlement file to an acquirer computer 122 containing transactions. The settlement file may be submitted periodically throughout the day, or more commonly, at the end of the business day.

A clearing and settlement process may include a process of reconciling a transaction. A clearing process is a process of exchanging financial details between an acquirer computer 122 and an issuer computer 126 to facilitate posting to an account and reconciliation of the user's settlement position. Settlement involves the delivery of securities from one user to another. In some embodiments, clearing and settlement can occur simultaneously. In some embodiments, the settlement process can be conducted using standard financial transaction messaging formats.

For example, standard BASE II settlement records or Single Message System (SMS) messages may be used. BASE II is a data processing network operated by VISA for the clearing and settlement of payment device transactions between payment device-honoring merchant acquirers and payment device issuers. This system can provide net daily account settlement among VISA member institutions.

In step 810, the acquirer sends the settlement file containing the transaction details, to the payment processing network 124. After the acquirer computer 122 associated with a merchant receives the settlement file containing the transactions of the secondary user 110 from the merchant computer 120, the acquirer computer 122 routes the settlement file to the payment processing network 124. The payment processing network 124 receives the settlement file comprising the reconciliation file and transaction details.

In step 815, the payment processing network 124 parses the settlement file. The payment processing network 124 evaluates the contents of the settlement file and determines the appropriate issuer computer 126 to which the settlement file can be transmitted. In embodiments of the claimed invention, the server computer 124(A) in the payment processing network 124 determines the appropriate issuer computer 126 to send the settlement file based on the contents of the settlement file. For example, the server computer 124(A) may parse out the second account identifier 116(A) contained in the settlement file and access the linked accounts database 124(H) to locate the corresponding linked primary account.

The payment processing network 124 may also retrieve the pre-authorization hold ID associated with the secondary account that was generated when the open-to-buy limit of the secondary account was increased with the granted amount from the primary account. The pre-authorization hold ID may then be combined with the transaction details contained in the settlement file to accurately reconcile the transaction against the pre-authorization hold against the primary account.

In step 820, the payment processing network 124 sends the settlement file to the issuer of the primary account for the transaction amount. The payment processing network 124 may then route the settlement file to the issuer computer 126 for the linked primary account using the messaging module 124(C) and the routing module 124(F). The payment processing network 124 can send the settlement file to the issuer computer 126 by any appropriate messaging means. The issuer computer 126 receives the settlement file comprising transaction details.

In step 825, the issuer of the primary account transmits the funds to the acquirer. The issuer computer 126 initiates the transfer of funds from a primary account of a primary user 102 to the payee (e.g. merchant). In embodiments, the issuer computer 126 initiates the process by debiting the transaction amount from the primary account (or by charging the primary account an amount equal to the transaction amount). After receiving the settlement file at the issuer computer 126, the issuer computer 126 parses the settlement file and determines the pre-authorization hold ID associated with the transaction and locates the appropriate primary account for the transaction. The issuer computer 126 charges the transaction amount against the appropriate primary account as an actual purchase. In the example above, the $25 transaction would be charged against the primary account and the $25 in monetary funds would be pulled. Once a transaction with the pre-authorization hold ID is received by the issuer computer 126, the pre-authorization hold is canceled. Once the transaction amount is charged against the primary account, the issuer computer 126 transmits the funds back to the acquirer computer 122 via the payment processing network 124.

In embodiments of the invention, the transactions are recorded on the primary account, and the recordation includes the secondary account number (in order to identify the linked card that performed the transaction) and the original transaction data that was stored when the transaction was authorized against the linked secondary account.

In step 830, the acquirer provides funds to the merchant. Once the acquirer computer 122 receives the funds from the issuer computer 126, the acquirer computer 122 credits an account associated with the merchant with the transaction amount.

In step 835, a new pre-authorization hold is established. Once the settlement process has completed, the payment processing network 124 determines whether the secondary account has any open-to-buy limit available. In the previous example, after the $25 transaction is settled, the secondary account still holds an open-to-buy limit of $75. However, since the pre-authorization hold against the primary account was canceled when the $25 transaction was settled, a new pre-authorization hold is needed. The process is similar to that described with respect to FIG. 6. The server computer 124(A) in the payment processing network 124 transmits an authorization request message to the issuer computer 126. Once the issuer computer 126 receives the authorization request message, the issuer computer 126 parses the authorization request message for at least the primary account number and secondary account number, the predetermined amount, and the designated hold period. The issuer computer 126 initiates an authorization hold on the primary account for the predetermined amount (e.g. $75 in the example) and for the designated hold period. A unique pre-authorization hold ID for the hold would also be generated (e.g. Pre-authorization Hold ID: 67890101). In embodiments, the amount of time the pre-authorization hold is valid matches the frequency for transaction sweeps designated by the primary user 102. The issuer computer 126 then tags the secondary account with the unique pre-authorization hold ID (e.g. Pre-authorization Hold ID: 67890101).

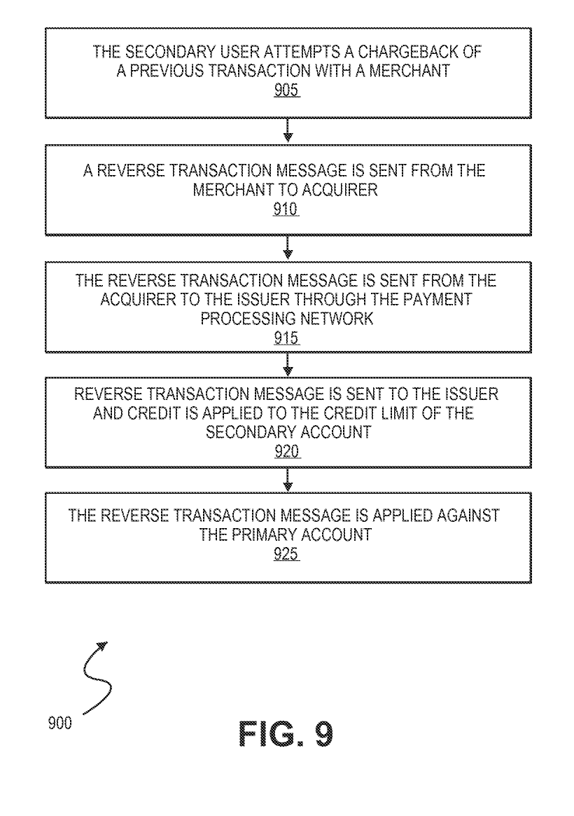

FIG. 9 is a flowchart of a method 900 for conducting a chargeback or reverse transaction for a financial transaction using a secondary account in a linked relationship with a primary account using a system 100 shown in FIG. 1.

In step 905, a secondary user 110 attempts a chargeback of a previous transaction with a merchant. The secondary user 110 may initiate the chargeback because the transaction was fraudulently conducted without the authorization of the secondary user 110, or the transaction may have been for goods or services that the secondary user 110 no longer needs. The chargeback may be conducted at a merchant access device 118 or via a second client computer 112 in communication with a merchant computer 120 via a communications medium 114 (e.g. the Internet).

In step 910, the reverse transaction message is sent from the merchant to the acquirer. Once the merchant approves the chargeback, the merchant computer 120 may generate a reverse transaction message. The reverse transaction message is then sent to an acquirer computer 122 for the merchant.

In step 915, the reverse transaction message is sent from the acquirer to a payment processing network 124. The acquirer computer 122 routes the reverse transaction message to the payment processing network 124 via any appropriate messaging means.

In step 920, the reverse transaction message is sent to the issuer and credit is applied to the credit limit (or open-to-buy limit) of the secondary account. Once the issuer computer 126 receives the reverse transaction message, the issuer computer 126 determines the appropriate secondary account based on the contents of the reverse transaction message. The issuer computer 126 then applies a credit against the credit limit of the secondary account. For example, if the original transaction amount was $50 and the credit limit granted to the secondary account was $100, and the available credit limit is $50, $50 would be credited to the secondary account. The available credit limit of the secondary account would thus be restored to the original $100 originally granted by the primary account to the secondary account.

In step 925, the reverse transaction message is applied against the primary account. As the actual funds for the transaction were debited from the primary account, the chargeback is also credited against the primary account. Thus, using the example described above, the issuer computer 126 would credit $50 to the primary account. The issuer computer 126 may further adjust the hold against the primary account. For example, when the secondary user 110 conducted the transaction that was settled against the primary account, $50 was debited from the primary account and the $100 pre-authorization hold against the primary account was replaced with a $50 pre-authorization hold. When the chargeback is conducted, the issuer computer 126 may replace the $50 pre-authorization hold against the primary account and restore it back to the $100 pre-authorization hold.

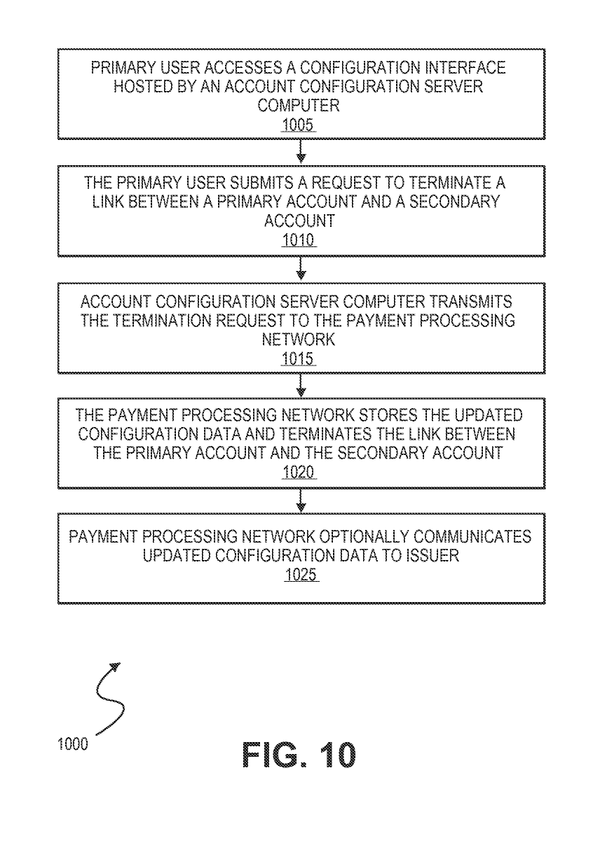

FIG. 10 is a flowchart of a method 1000 for terminating or severing a link relationship between a secondary account and a primary account using a system 100 shown in FIG. 1.

In step 1005, the primary user 102 accesses a configuration interface 400 hosted by an account configuration server computer 128. The primary user can access the configuration interface 400 on a first client computer 104 through a communications medium 106, such as the Internet. In some embodiments, the configuration interface 400 can be a hosted website with fields and options that allow the primary user 102 to customize enrollment and usage settings. In some embodiments, the configuration interface 400 may be hosted by a payment processing network 124 or an issuer computer 126. A configuration interface module 128(B) can access a configuration interface database 128(D) in order to retrieve and present the hosted website for display on the first client computer 104.

In step 1010, the primary user 102 submits a request to terminate a link between a primary account and a secondary account. The primary user 102 inputs configuration data into the configuration interface to terminate or sever a link between the primary account and the secondary account.

In step 1015, the account configuration server computer 128 transmits the termination request to the payment processing network 124. The termination request contains the severance data input by the primary user 102 and is sent as updated configuration data. The payment processing network 124 receives the severance data to unlink the primary account and the secondary account. The termination request may be sent as updated configuration data similar to the configuration data transmitted to initially creating the link between the primary account and the secondary account. The account configuration server computer 128 comprises a routing module 128(C) that can transmit the updated configuration data to the payment processing network 124. In some embodiments, the routing module 128(C) transmits the updated configuration data to the issuer computer 126 that issued the primary account and the secondary account. In some embodiments, the updated configuration data is received by a messaging module 124(C) contained in a server computer 124(A) in the payment processing network 124.

In step 1020, the payment processing network 124 stores and updates configuration data and terminates the link between the primary account and the secondary account. In embodiments of the claimed invention, the updated configuration data is stored in a linked accounts database 124(H). The updated configuration data can be stored in a data table as depicted in FIG. 5. Once the link between the primary account and the secondary account has been severed or terminated, the secondary account is capable of being used independently of the primary account.

In step 1025, the payment processing network 124 optionally communicates the updated configuration data to the issuer. In embodiments of the invention, the payment processing network 124 can further send the configuration data received from the account configuration server computer 128 to the issuer computer 126 by any appropriate messaging means.

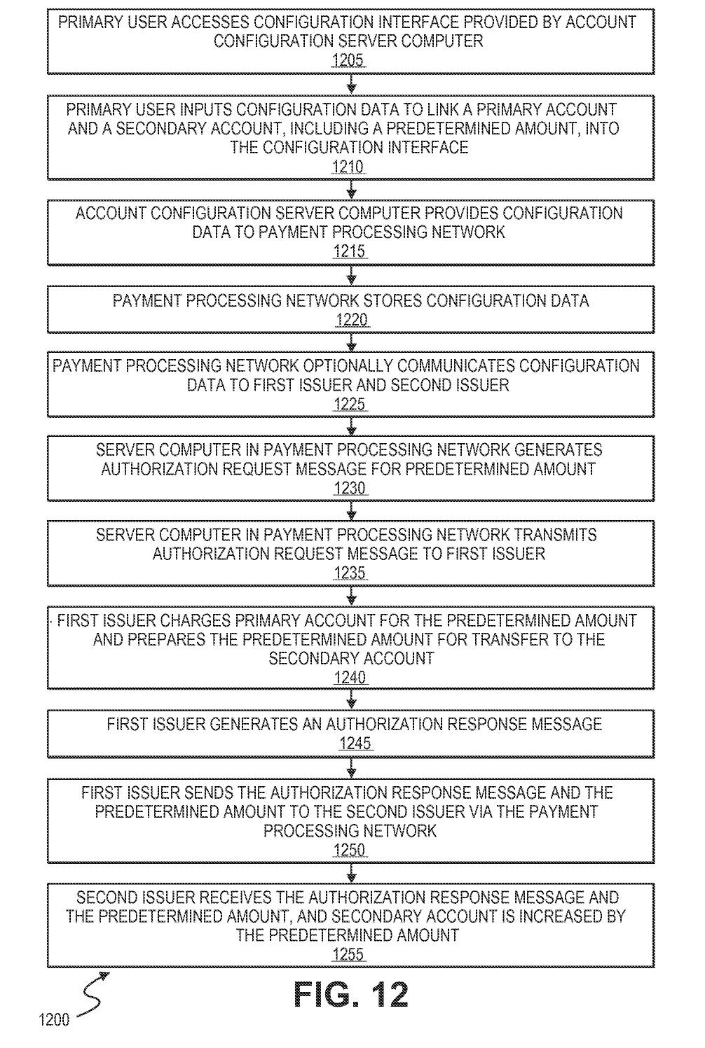

FIG. 12 is a flowchart of a method 1200 for enrolling a secondary account associated with a second issuer computer 1128 into a linked relationship with a primary account associated with a first issuer computer 1126 and setting up the secondary account for payment transactions using a system 1100 shown in FIG. 11.

The messaging format for establishing the funding of the secondary account and placing the hold on the primary account can be accomplished using different messaging systems. For example, a Single Message System (SMS), a form of electronic message, may be used and allows for both authorization and capture of funds in a single message. Other messaging systems include Base I and Base II. Base I is an electronic message that notifies an issuer to authorize and hold pending a future file with transaction details. Base II is a file that can be sent to an issuer computer with actual transaction details. For example, a Base II settlement file with a “05” file indicator indicates that the file is for a transaction.

In embodiments where actual monetary funds are transferred from the first issuer computer 1126 to the secondary account in the second issuer computer 1128, another messaging system may be used. For example, an original credit transaction may be required where there are multiple issuers and actual funds need to be transferred. An authorization is sent to the first issuer computer 1126 to authorize and capture funds from the primary account. Through an original credit transaction, the funds are deposited to the secondary account in the second issuer computer 1128.

In some embodiments where the first issuer computer 1126 places a pre-authorization hold and does not transfer actual funds to a second issuer computer 1128, a Base I message may be sent from the payment processing network 1124 to the first issuer computer 1126 requesting a pre-authorization hold be placed against the primary account for a predetermined amount. Later, during a clearing and settlement process, a Base II file can be sent from the processing network 1124 to the first issuer computer 1126 with the transaction details for clearing and settlement against the primary account.

In step 1205, the primary user 1102 accesses a configuration interface 400 provided by an account configuration server computer 1130. The primary user can access the configuration interface 400 on a first client computer 1104 through a communications medium 1106, such as the Internet. In some embodiments, the configuration interface 400 can be a hosted website with fields and options that allow the primary user 1102 to customize enrollment and usage settings. In some embodiments, the configuration interface 400 may be hosted by a payment processing network 1124 or a first issuer computer 1126. A configuration interface module in the account configuration server computer 1130 can access a configuration interface database in order to retrieve and present the hosted website for display on the first client computer 1104.

In step 1210, the primary user 1102 inputs configuration data to link a primary account and a secondary account of a secondary user 1110 into the configuration interface 400. The configuration data also may include a predetermined amount of the credit limit of the primary account to grant to the secondary account for usage. In some embodiments, the primary user 1102 inputs the account numbers for a primary account and a secondary account, where the secondary account is to be linked to the first account and granted a portion of the primary account's open-to-buy or credit limit. The predetermined amount can be a set monetary amount or a percentage of the credit limit of the primary account. For example, the primary user 1102 may choose to grant $100 of the open-to-buy or credit limit of the primary account to the secondary account. The configuration data can further comprise data regarding the frequency of top-ups, spending restrictions, and notification/alert settings.

In step 1215, the account configuration server computer 1130 provides configuration data to payment processing network 1124. The account configuration server computer 1130 comprises a routing module that can transmit the configuration data to the payment processing network 1124. In some embodiments, the configuration data is received by a messaging module contained in a server computer in the payment processing network 1124. The payment processing network 1124 receives the configuration data to link the primary (or first) account to the secondary (or second) account, indicating an allocation of a predetermined amount of an account limit (or credit limit) of the secondary account granted by the primary account.

In step 1220, the payment processing network 1124 stores the configuration data. In embodiments of the claimed invention, the configuration data is stored in a linked accounts database. The configuration data can be stored in a data table as depicted in FIG. 5 and may contain all the account details for the primary and secondary accounts that are required for processing financial transactions.

In step 1225, the payment processing network 1124 optionally communicates configuration data to the first issuer and second issuer. In embodiments of the invention, the payment processing network 1124 can further send the configuration data received from the account configuration server computer 1130 to the first issuer computer 1126 and the second issuer computer 1128 by any appropriate messaging means. The first issuer computer 1126 and the second issuer computer 1128 receive the configuration data to link the primary (or first) account to the secondary (or second) account, indicating an allocation of a predetermined amount of an account limit (or credit limit) of the secondary account granted by the primary account.

In step 1230, the server computer in the payment processing network 1124 generates an authorization request message for the predetermined amount of the credit limit of the primary account to grant to the secondary account. For example, the authorization request message may indicate a predetermined amount of $100 to be granted to the secondary account for a period of one month. In other words, the secondary account will be granted access to $100 of the credit limit of the primary account for a one month period.

In step 1235, the server computer in the payment processing network 1124 transmits the authorization request message to the issuer of the primary account. The payment processing network 1124 transmits the authorization request message via a messaging module contained in the server computer. The destination of the authorization request message is determined based on the content of the authorization request message indicating the appropriate first issuer computer 1126. The routing module determines the appropriate first issuer computer 1126 to which the authorization request message is to be transmitted by the messaging module.

In step 1240, first issuer charges the primary account for the predetermined amount and prepares the predetermined amount for transfer to the secondary account. Once the first issuer computer 1126 receives the authorization request message, the first issuer computer 1126 parses the authorization request message for at least the primary account number and secondary account number, and the predetermined amount. The first issuer computer 1126 may then charge the primary account with the predetermined amount and prepare the funds for transfer from the primary account to the secondary account.

In step 1245, first issuer generates an authorization response message. The authorization response may contain an approval of the transfer of funds equal to the predetermined amount from the primary account to the secondary account.

In step 1250, first issuer sends the authorization response message and the predetermined amount to the second issuer via the payment processing network 1124. Funds equaling the predetermined amount are transmitted by the payment processing network 1124 to the second issuer computer 1128. The payment processing network 1124 can update the linkage status of the primary account and the secondary account by updating the Linkage Status field corresponding to the primary account and secondary account in the data table shown in FIG. 5.

In step 1255, the second issuer receives the authorization response message and the predetermined amount, and the secondary account is increased by the predetermined amount. When the authorization response message indicates approval of the pre-authorization, the second issuer computer 1128 increases the open-to-buy limit of the secondary account by the predetermined amount. For example, if the predetermined amount was for $100, the second issuer computer 1128 would increase the open-to-buy limit of the secondary account by $100 and tag the secondary account with the unique pre-authorization hold ID (e.g. Pre-authorization Hold ID: 76589010).

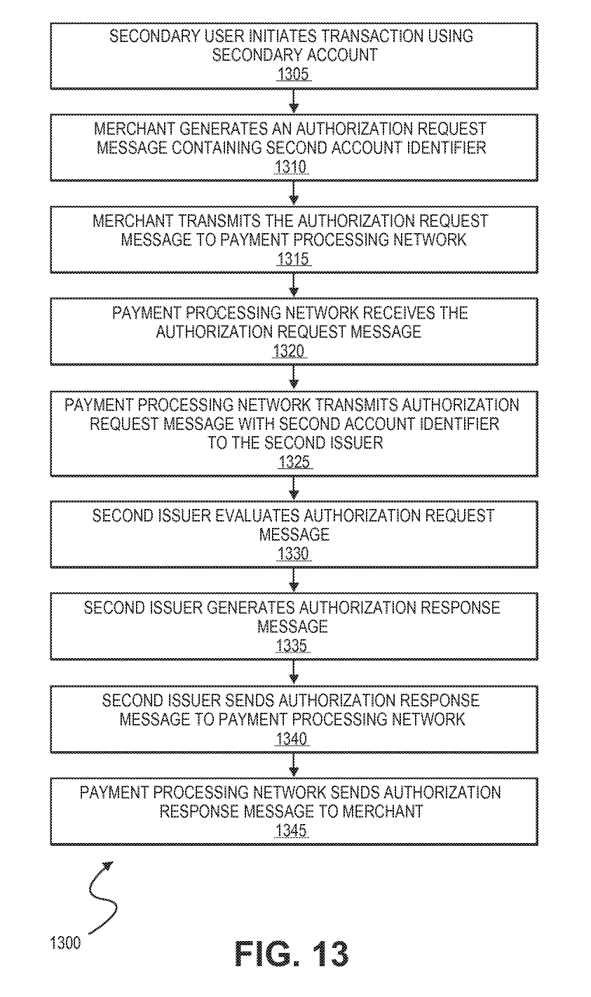

FIG. 13 is a flowchart of a method 1300 for conducting a financial transaction using a secondary account associated with a second issuer computer 1128 in a linked relationship with a primary account associated with a first issuer computer 1126, using a system 1100 shown in FIG. 11.

In step 1305, a secondary user 1110 initiates a transaction using a secondary account. In a typical transaction, the secondary user 1110 engages in a transaction for goods or services at a merchant associated with a merchant computer 1120 using a second client computer 1112 and a second payment device 1116 such as a credit card or mobile phone. For example, the secondary user 1110 may use their Internet-enabled mobile phone to access a merchant website to conduct a transaction using their second payment device 1116. In other embodiments, the secondary user 1110 may swipe the credit card through a merchant access device 1118 (e.g. POS terminal) or, in another embodiment, may take a wireless phone and may pass it near a contactless reader in a POS terminal.

In step 1310, the merchant generates an authorization request message containing a second account identifier 1116(A) contained in the second payment device 1116. The authorization request message may be generated by either a web server in the merchant computer 1120 or by a merchant access device 1118 (e.g. a POS terminal). The authorization request message may be generated in any suitable format. Transactions details may be comprised of, but is not limited to, the following: secondary user name, secondary user billing address, secondary user shipping address, secondary user phone number, second account identifier 1116(A) (e.g. second account number, etc.), items purchased, item prices, etc.

In step 1315, the merchant transmits the authorization request message to payment processing network 1124. The authorization request message may be transmitted to the payment processing network 1124 by the merchant computer 1120 through an acquirer computer 1122. The authorization request message may be transmitted in any suitable format.

In step 1320, the payment processing network 1124 receives the authorization request message. The payment processing network 1124 receives the authorization request message requesting authorization to conduct a transaction for a transaction amount using a secondary account of a secondary user 1110, where the transaction is being conducted between the secondary user 1110 and a payee (e.g. a merchant). A messaging module in the payment processing network 1124 may receive authorization request messages from the acquirer computer 1122 and send authorization request messages to the second issuer computer 1128. A transaction review module in the payment processing network 1124 may parse the authorization request message to determine the appropriate second issuer computer 1128 to send the authorization request message to.

In step 1325, the payment processing network transmits authorization request message with second account identifier to the second issuer. After receiving the authorization request message, the payment processing network 1124 may then transmit the authorization request message to the appropriate second issuer computer 1128 associated with the second payment device 1116.

In step 1330, the second issuer evaluates the authorization request message. The second issuer computer 1128 receives the authorization request message requesting authorization to conduct a transaction for a transaction amount using a secondary account of a secondary user 1110, where the transaction is being conducted between the secondary user 1110 and a payee (e.g. a merchant). The second issuer computer 1128 may then determine whether the transaction can be authorized. The second issuer computer 1128 may evaluate the contents of the authorization request message to determine whether the transaction satisfies the conditions and setting established by the primary user 1102 with respect to spending restrictions of the granted credit limit of the primary account. For example, the primary user 1102 may have specified that the granted credit limit was only valid for transactions for food or gas. If the transaction details in the authorization request message indicate that the transaction was for the purchase of fruits and bread, the second issuer computer 1128 may approve the transaction. However, if the transaction details in the authorization request message indicate that the transaction was for the purchase of alcoholic beverages, the second issuer computer 1128 may decline the transaction.

In step 1335, the second issuer generates an authorization response message. The second issuer computer 1128 generates the authorization response message and transmits the authorization response message to the payment processing network 1124. The authorization response message can indicate whether the transaction contained in the authorization request message has been authorized or has been declined by the second issuer computer 1128.

In step 1340, the second issuer sends authorization response message to the payment processing network. The second issuer computer 1128 can send the authorization response message to the payment processing network 1124. The message may be sent by an appropriate messaging means.

In step 1345, the payment processing network 1124 sends the authorization response message back to the merchant. The payment processing network 1124 may send the authorization response message back to the acquirer computer 1122, which may then transmit the authorization response message back to the merchant computer 1120. The merchant computer 1120 may parse the authorization response message. If the transaction was approved, the merchant computer 1120 may store the transaction data in a reconciliation file for future clearing and settlement processes. In some embodiments, the reconciliation file is stored at the payment processing network 1124.

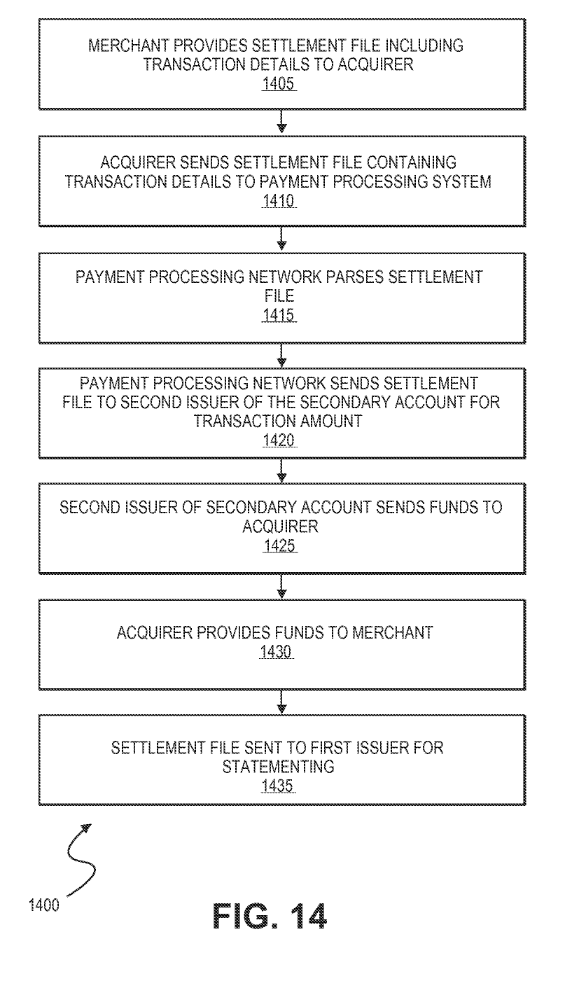

FIG. 14 is a flowchart of a method 1400 of clearing and settling a financial transaction involving a secondary account associated with a second issuer computer 1128 in a linked relationship with a primary account associated with a first issuer computer 1126, using a system 1100 shown in FIG. 11.

In step 1405, the merchant provides the settlement file containing transaction details to the acquirer. The settlement file may contain a reconciliation file containing all the transaction details for transactions conducted between the secondary user 1110 and the merchant using the open-to-buy limit or credit limit granted by the primary user 1102 to the secondary account of the secondary user 1110. The transaction may have been conducted through either the secondary user 1110 using a second client computer 1112 to access a website hosted by a merchant computer 1120 through a communications medium 1114, or by the secondary user 1110 using a second payment device 1116 to interact with a merchant access device 1118 (e.g. a POS terminal). In either scenario, the merchant will send a settlement file to an acquirer computer 1122 containing transactions. The settlement file may be submitted periodically throughout the day, or more commonly, at the end of the business day.

A clearing and settlement process may include a process of reconciling a transaction. A clearing process is a process of exchanging financial details between an acquirer computer 1122 and a first issuer computer 1126 to facilitate posting to an account and reconciliation of the user's settlement position. Settlement involves the delivery of securities from one user to another. In some embodiments, clearing and settlement can occur simultaneously. In some embodiments, the settlement process can be conducted using standard financial transaction messaging formats. For example, standard BASE II settlement records or Single Message System (SMS) messages may be used.

In step 1410, the acquirer sends the settlement file containing the transaction details, to the payment processing network 1124. After the acquirer computer 1122 associated with a merchant receives the settlement file containing the transactions of the secondary user 1110 from the merchant computer 1120, the acquirer computer 1122 may then route the settlement file to the payment processing network 1124. The payment processing network 1124 receives the settlement file comprising the reconciliation file and transaction details.

In step 1415, the payment processing network 1124 parses the settlement file. The payment processing network 1124 evaluates the contents of the settlement file and determines the appropriate first issuer computer 1126 to which the settlement file can be transmitted. In embodiments of the claimed invention, the server computer in the payment processing network 1124 determines the appropriate first issuer computer 1126 to send the settlement file based on the contents of the settlement file. For example, the server computer in the payment processing network 1124 may parse out the second account identifier 1116(A) contained in the settlement file and access the linked accounts database in the payment processing network 1124 to locate the corresponding linked primary account.

The payment processing may also retrieve the pre-authorization hold ID associated with the secondary account that was generated when the open-to-buy limit of the secondary account was increased with the granted amount from the primary account. The pre-authorization hold ID may then be combined with the transaction details contained in the settlement file to accurately reconcile the transaction against the primary account.

In step 1420, the payment processing network 1124 sends the settlement file to the second issuer of the secondary account for the transaction amount. The payment processing network 1124 may route the settlement file to the second issuer computer 1128 for the linked primary account using the messaging module and the routing module contained in the server computer of the payment processing network 1124. The payment processing network 1124 can send the settlement file to the second issuer computer 1128 by any appropriate messaging means. The second issuer computer 1128 receives the settlement file comprising transaction details.

In step 1425, the second issuer of the secondary account transmits the funds to the acquirer. The second issuer computer 1128 initiates the transfer of funds from a secondary account of a secondary user 1102 to the payee (e.g. merchant). In embodiments, the second issuer computer 1128 initiates the process by debiting the transaction amount from the secondary account (or by charging the secondary account an amount equal to the transaction amount). After receiving the settlement file at the second issuer computer 1128, the second issuer computer 1128 parses the settlement file and determines the appropriate secondary account for the transaction. The secondary issuer computer 1128 charges the transaction amount against the appropriate secondary account as an actual purchase. Once the transaction amount is charged against the primary account, the secondary issuer computer 1128 transmits the funds back to the acquirer computer 1122 via the payment processing network 1124.

In some embodiments, where the first issuer computer 1126 has pre-authorization hold, the first issuer computer 1126 initiates the transfer of funds from the primary account of the primary user 1102 to the payee (e.g. merchant). In embodiments, the first issuer computer 1126 initiates the process by debiting the transaction amount from the primary account (or by charging the primary account an amount equal to the transaction amount). After receiving the settlement file at the first issuer computer 1126, the first issuer computer 1126 parses the settlement file and determines the pre-authorization hold ID associated with the transaction and locates the appropriate primary account for the transaction. The first issuer computer 1126 charges the transaction amount against the appropriate primary account as an actual purchase. In the example above, the $25 transaction would be charged against the primary account and the $25 in monetary funds would be pulled. Once a transaction with the pre-authorization hold ID is received by the first issuer computer 1126, the pre-authorization hold is canceled. Once the transaction amount is charged against the primary account, the issuer computer 1126 transmits the funds back to the acquirer computer 1122 via the payment processing network 1124.

In these embodiments, a new pre-authorization hold may need to be established. Once the settlement process has completed, the payment processing network 1124 determines whether the secondary account has any open-to-buy limit available. For example, after transactions totaling $55 are is settled, the secondary account still holds an open-to-buy limit of $45. However, since the pre-authorization hold against the primary account was canceled when the transactions were settled, a new pre-authorization hold is needed. The process is similar to that described with respect to FIG. 6. The server computer in the payment processing network 1124 transmits an authorization request message to the first issuer computer 1126. Once the first issuer computer 1126 receives the authorization request message, the first issuer computer 1126 parses the authorization request message for at least the primary account number and secondary account number, the remaining amount of open-to-buy on the secondary card, and the designated hold period. The first issuer computer 1126 initiates an authorization hold on the primary account for the remaining amount of open-to-buy on the secondary card (e.g. $45 in the example) and for the designated hold period. A unique pre-authorization hold ID for the hold would also be generated (e.g. Pre-authorization Hold ID: 98890101). In embodiments, the amount of time the pre-authorization hold is valid matches the frequency for transaction sweeps designated by the primary user 1102. The first issuer computer 1126 then tags the secondary account with the unique pre-authorization hold ID (e.g. Pre-authorization Hold ID: 98890101).

In step 1430, the acquirer provides funds to the merchant. Once the acquirer computer 1122 receives the funds from the second issuer computer 1128, the acquirer computer 1122 credits an account associated with the merchant with the transaction amount.

In step 1435, the settlement file is sent to the first issuer for statementing. As the funds were previously deducted from the primary account, clearing and settlement is not required. However, the settlement file is sent to the first issuer computer 1126 so that the transactions can be recorded on the primary account statement. The recordation includes the secondary account number (in order to identify the linked card that performed the transaction) and the original transaction data that was stored when the transaction was authorized against the linked secondary account.

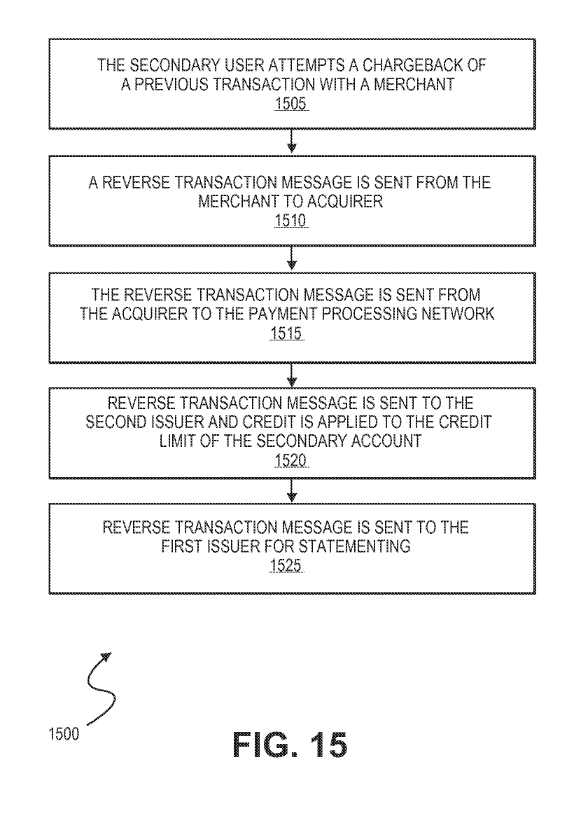

FIG. 15 is a flowchart of a method 1500 for conducting a chargeback or reverse transaction for a financial transaction using a secondary account associated with a second issuer computer 1128 in a linked relationship with a primary account associated with a second issuer computer 1126, using a system 1100 shown in FIG. 11.

In step 1505, a secondary user 1110 attempts a chargeback of a previous transaction with a merchant. The secondary user 1110 may initiate the chargeback because the transaction was fraudulently conducted without the authorization of the secondary user 1110, or the transaction may have been for a good or service that the secondary user 1110 no longer needs. The chargeback may be conducted at a merchant access device 1118 or via a second client computer 1112 in communication with a merchant computer 1120 via a communications medium 1114 (e.g. the Internet).

In step 1510, the reverse transaction message is sent from the merchant to the acquirer. Once the merchant approves the chargeback, the merchant computer 1120 may generate a reverse transaction message. The reverse transaction message is then sent to an acquirer computer 1122 associated with the merchant.

In step 1515, the reverse transaction message is sent from the acquirer to a payment processing network 1124. The acquirer computer 1122 routes the reverse transaction message to the payment processing network 1124 via any appropriate messaging means.

In step 1520, the reverse transaction message is sent to the second issuer and credit is applied to the credit limit (or open-to-buy limit) of the secondary account. Once the second issuer computer 1128 receives the reverse transaction message, the second issuer computer 1128 determines the appropriate secondary account based on the contents of the reverse transaction message. The second issuer computer 1128 then applies a credit against the credit limit of the secondary account. For example, if the original transaction amount was $50 and the credit limit granted to the secondary account was $100, and the available credit limit is $50, $50 would be credited to the secondary account. The available credit limit of the secondary account would thus be restored to the original $100 originally granted by the primary account to the secondary account.

In step 1525, the reverse transaction message is sent to the first issuer for statementing. As actual funds were previously deducted from the primary account, the chargeback is not done against the primary account. However, the reverse transaction message may be sent to the first issuer computer 1126 so that the transactions can recorded on the primary account statement.

In embodiments where a pre-authorization hold is against the primary account, the chargeback may also be credited against the primary account. Thus, using the example described above, the first issuer computer 1126 would credit $50 to the primary account. For example, when the secondary user 1110 conducted the transaction that was settled against the primary account, $50 was debited from the primary account and the $100 pre-authorization hold against the primary account was replaced by a $50 pre-authorization hold. When the chargeback is conducted, the first issuer computer 1126 may replace the $50 pre-authorization hold against the primary account and restore it back to the $100 pre-authorization hold.

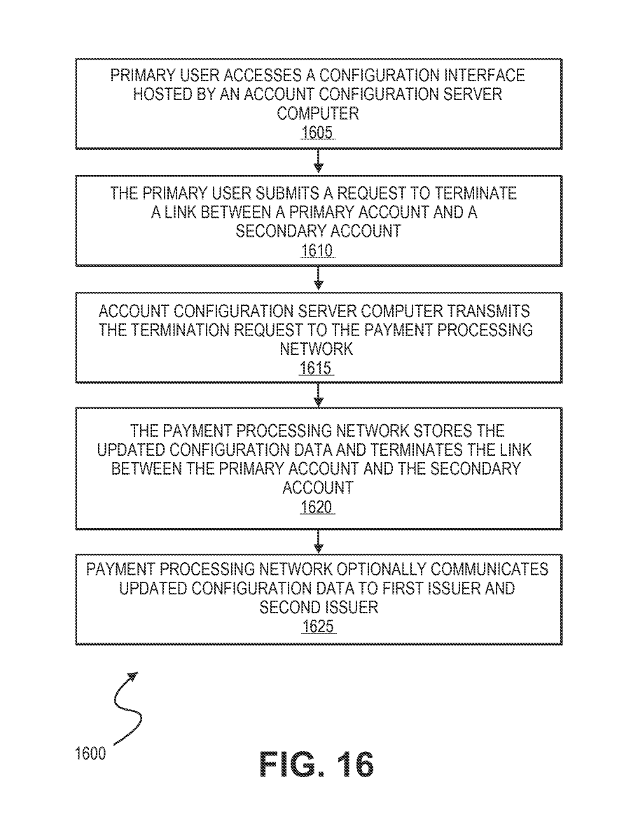

FIG. 16 is a flowchart of a method 1600 for terminating or severing a link relationship between a secondary account and a primary account using a system 1100 shown in FIG. 11.

In step 1605, the primary user 1102 access a configuration interface hosted by an account configuration server computer 1130. The primary user 1102 can access the configuration interface 400 on a first client computer 1104 through a communications medium 1106, such as the Internet. In some embodiments, the configuration interface 400 can be a hosted website with fields and options that allow the primary user 1102 to customize enrollment and usage settings. In some embodiments, the configuration interface may be hosted by a payment processing network 1124 or a first issuer computer 1126. A configuration interface module can access a configuration interface database in order to retrieve and present the hosted website for display on the first client computer 1104.

In step 1610, the primary user 1102 submits a request to terminate a link between a primary account and a secondary account. The primary user 1102 inputs configuration data into the configuration interface to terminate or sever a link between the primary account and the secondary account.

In step 1615, the account configuration server computer 1130 transmits the termination request to the payment processing network 1124. The termination request contains the severance data input by the primary user 1102 and is sent as updated configuration data. The payment processing network 1124 receives the severance data to unlink the primary account and the secondary account. The termination request may be sent as updated configuration data similar to the configuration data transmitted to initially creating the link between the primary account and the secondary account. The account configuration server computer 1130 comprises a routing module that can transmit the updated configuration data to the payment processing network 1124. In some embodiments, the updated configuration data is received by a messaging module contained in a server computer in the payment processing network 1124.

In step 1620, the payment processing network 1124 stores and updates configuration data and terminates the link between the primary account and the secondary account. In embodiments of the claimed invention, the updated configuration data is stored in a linked accounts database. The updated configuration data can be stored in a data table as depicted in FIG. 5. Once the link between the primary account and the secondary account has been severed or terminated, the secondary account is capable of being used independently of the primary account.

In step 1625, the payment processing network 1124 optionally communicates the updated configuration data to the first issuer and the second issuer. In embodiments of the invention, the payment processing network 1124 can further send the configuration data received from the account configuration server computer 1130 to the first issuer computer 1126 associated with the primary account and the second issuer computer 1128 associated with the secondary account. The configuration data may be sent by any appropriate messaging means.

### III. Technical Benefits

A benefit of embodiments of the invention is the ability to link a secondary account of a second user to a primary account of a first user, and then subsequently sever or terminate the link. In prior solutions, an issuer would have to generate a new account for the purposes of creating a linked relationship. The benefit of embodiments of the invention is the ability for pre-existing accounts and payment devices can be linked without requiring issuers to expend resources to create or establish new accounts. The issuer further does not need to produce and mail new payment devices to the second user. Furthermore, at a point in time where the linked relationship is to be severed or terminated, the secondary account can function once again function independently from the primary account. Thus, the linking and unlinking process can be done repeatedly, without the expense of significant resources by the issuer to open and close accounts, or generate account materials (e.g. payment devices).

Embodiments of the invention provide the technical benefits of efficiency and conserving resources. By utilizing existing systems and messaging capabilities, but implementing new methods of control and logic at payment processing networks and issuer computers, the systems and methods described do not require infrastructure changes in order to implement.

Embodiments of the invention further provide the benefits of conserving resources. In prior solutions, the account identifier in the authorization request message was changed from the account identifier of the secondary account to the account identifier of the primary account. In this scheme, when the transaction authorization request is received by the payment processing network, the transaction message is modified and the transaction is posted against the primary account. The authorization request message sent back to the merchant would also contain an account identifier for the primary account. However, when a chargeback is necessary, in order for the secondary user to be able to obtain a chargeback, additional processes would be required. Since the transaction was posted against the primary account from the initial authorization steps, the authorization response message contained the first account identifier, and the merchant does not recognize the secondary account or the secondary account identifier. Thus, additional steps would be required to replace the primary account identifier with the secondary account number in order to complete the authorization steps.

### IV. Additional Embodiments

An additional embodiment of the invention involves a system as depicted in FIG. 11 with a first issuer computer 1126 associated with a primary account and a second issuer computer 1128 associated with a secondary account. In this embodiment, the first issuer computer 1126 does not transfer actual funds from the primary account to the secondary account, but places a pre-authorization hold against the primary account. Such an embodiment may be possible where a payment processing network 1124 steps in and provides the funds to the secondary account on behalf of the primary account. This beneficially allows for a linked relationship where the primary user is not subject to interest or fees for the portion of the primary account's open-to-buy limit or credit limit granted to the secondary user.

In order to establish a link between the primary account and the secondary account and grant a portion of the primary account's credit limit, according to this embodiment, the primary user 1102 accesses a configuration interface 400 provided by an account configuration server computer 1130. The primary user can access the configuration interface 400 on a first client computer 1104 through a communications medium 1106, such as the Internet. In some embodiments, the configuration interface 400 can be a hosted website with fields and options that allow the primary user 1102 to customize enrollment and usage settings. In some embodiments, the configuration interface 400 may be hosted by a payment processing network 1124 or a first issuer computer 1126. A configuration interface module in the account configuration server computer 1130 can access a configuration interface database in order to retrieve and present the hosted website for display on the first client computer 1104.

The primary user 1102 inputs configuration data to link a primary account and a secondary account of a secondary user 1110 into the configuration interface 400. The configuration data also may include a predetermined amount of the credit limit of the primary account to grant to the secondary account for usage. In some embodiments, the primary user 1102 inputs the account numbers for a primary account and a secondary account, where the secondary account is to be linked to the first account and granted a portion of the primary account's open-to-buy or credit limit. The predetermined amount can be a set monetary amount or a percentage of the credit limit of the primary account. For example, the primary user 1102 may choose to grant $100 of the open-to-buy or credit limit of the primary account to the secondary account. The configuration data can further comprise data regarding the frequency of top-ups, spending restrictions, and notification/alert settings.

The account configuration server computer 1130 provides configuration data to payment processing network 1124. The account configuration server computer 1130 comprises a routing module that can transmit the configuration data to the payment processing network 1124. In some embodiments, the configuration data is received by a messaging module contained in a server computer in the payment processing network 1124. The payment processing network 1124 receives the configuration data to link the primary (or first) account to the secondary (or second) account, indicating an allocation of a predetermined amount of an account limit (or credit limit) of the secondary account granted by the primary account.

The payment processing network 1124 stores the configuration data. In embodiments of the claimed invention, the configuration data is stored in a linked accounts database. The configuration data can be stored in a data table as depicted in FIG. 5 and may contain all the account details for the primary and secondary accounts that are required for processing financial transactions.

The payment processing network 1124 optionally communicates configuration data to the first issuer and second issuer. In embodiments of the invention, the payment processing network 1124 can further send the configuration data received from the account configuration server computer 1130 to the first issuer computer 1126 and the second issuer computer 1128 by any appropriate messaging means. The first issuer computer 1126 and the second issuer computer 1128 receive the configuration data to link the primary (or first) account to the secondary (or second) account, indicating an allocation of a predetermined amount of an account limit (or credit limit) of the secondary account granted by the primary account.

The server computer in the payment processing network 1124 generates an authorization request message for the predetermined amount of the credit limit of the primary account to grant to the secondary account. In other words, the payment processing network 1124 initiates an authorization hold on the primary account for the predetermined amount by generating the authorization request message for the predetermined amount. The authorization request message can also contain the designated hold period for the predetermined amount. For example, the authorization request message may indicate a predetermined amount of $100 to be granted to the secondary account for a pre-authorization hold period of one month. In other words, the secondary account will be granted access to $100 of the credit limit of the primary account for a one month period.

The server computer in the payment processing network 1124 transmits the authorization request message to the issuer of the primary account. The payment processing network 1124 transmits the authorization request message via a messaging module contained in the server computer. The destination of the authorization request message is determined based on the content of the authorization request message indicating the appropriate first issuer computer 1126. The routing module determines the appropriate first issuer computer 1126 to which the authorization request message is to be transmitted by the messaging module.

The first issuer computer 1126 initiates an authorization hold on the primary account for the predetermined amount and for the designated hold period. In this embodiment, the primary account is not charged for the predetermined amount. This embodiment is possible where the payment processing network 1124 steps in and insures the predetermined amount on the secondary account so that the first issuer computer 1126 does not assume the financial risk of granting credit to an account in another financial institution. For example, if the predetermined amount was for $100 and the frequency for transaction sweeps was monthly, a pre-authorization hold of $100 would be placed on the open-to-buy limit of the primary account, and a unique pre-authorization hold ID for the hold would be generated (e.g. Pre-authorization Hold ID: 89589010). In embodiments, the amount of time the pre-authorization hold is valid matches the frequency for transaction sweeps designated by the primary user 1102.

The first issuer computer 1126 may then generate an authorization response message that may contain an approval of the pre-authorization hold equal to the predetermined amount.

The first issuer computer 1126 may then send the authorization response message and the predetermined amount to the second issuer computer 1128 via the payment processing network 1124. The payment processing network 1124 can update the linkage status of the primary account and the secondary account by updating the Linkage Status field corresponding to the primary account and secondary account in the data table shown in FIG. 5.

The second issuer computer 1128 receives the authorization response message indicating approval of the pre-authorization hold, and increases the open-to-buy limit of the secondary account by the predetermined amount. For example, if the predetermined amount was for $100, the second issuer computer 1128 would increase the open-to-buy limit of the secondary account by $100 and tag the secondary account with the unique pre-authorization hold ID (e.g. Pre-authorization Hold ID: 89589010).

In order to conduct a financial transaction using a secondary account associated with a second issuer computer 1128 in a linked relationship with a primary account associated with a first issuer computer 1126, according to this embodiment, a secondary user 1110 initiates a transaction using a secondary account. In a typical transaction, the secondary user 1110 engages in a transaction for goods or services at a merchant associated with a merchant computer 1120 using a second client computer 1112 and a second payment device 1116 such as a credit card or mobile phone. For example, the secondary user 1110 may use their Internet-enabled mobile phone to access a merchant website to conduct a transaction using their second payment device 1116. In other embodiments, the secondary user 1110 may swipe the credit card through a merchant access device 1118 (e.g. POS terminal) or, in another embodiment, may take a wireless phone and may pass it near a contactless reader in a POS terminal.

An authorization request message may be generated by either a web server in the merchant computer 1120 or by a merchant access device 1118 (e.g. a POS terminal). The authorization request message may be generated in any suitable format. Transactions details may be comprised of, but is not limited to, the following: secondary user name, secondary user billing address, secondary user shipping address, secondary user phone number, second account identifier 1116(A) (e.g. second account number, etc.), items purchased, item prices, etc.

The authorization request message may be transmitted to the payment processing network 1124 by the merchant computer 1120 through an acquirer computer 1122. The authorization request message may be transmitted in any suitable format.

The payment processing network 1124 receives the authorization request message requesting authorization to conduct a transaction for a transaction amount using a secondary account of a secondary user 1110, where the transaction is being conducted between the secondary user 1110 and a payee (e.g. a merchant). A messaging module in the payment processing network 1124 may receive authorization request messages from the acquirer computer 1122 and send authorization request messages to the second issuer computer 1128. A transaction review module in the payment processing network 1124 may parse the authorization request message to determine the appropriate second issuer computer 1128 to send the authorization request message to.

After receiving the authorization request message, the payment processing network 1124 may then transmit the authorization request message to the appropriate second issuer computer 1128 associated with the second payment device 1116.

The second issuer computer 1128 receives the authorization request message requesting authorization to conduct a transaction for a transaction amount using a secondary account of a secondary user 1110, where the transaction is being conducted between the secondary user 1110 and a payee (e.g. a merchant). The second issuer computer 1128 may then determine whether the transaction can be authorized. The second issuer computer 1128 may evaluate the contents of the authorization request message to determine whether the transaction satisfies the conditions and setting established by the primary user 1102 with respect to spending restrictions of the granted credit limit of the primary account. For example, the primary user 1102 may have specified that the granted credit limit was only valid for transactions for food or gas. If the transaction details in the authorization request message indicate that the transaction was for the purchase of fruits and bread, the second issuer computer 1128 may approve the transaction. However, if the transaction details in the authorization request message indicate that the transaction was for the purchase of alcoholic beverages, the second issuer computer 1128 may decline the transaction.

The second issuer computer 1128 may then generate an authorization response message and transmit the authorization response message to the payment processing network 1124. The authorization response message can indicate whether the transaction contained in the authorization request message has been authorized or has been declined by the second issuer computer 1128.

The payment processing network 1124 may send the authorization response message back to the acquirer computer 1122, which may then transmit the authorization response message back to the merchant computer 1120. The merchant computer 1120 may parse the authorization response message. If the transaction was approved, the merchant computer 1120 may store the transaction data in a reconciliation file for future clearing and settlement processes. In some embodiments, the reconciliation file is stored at the payment processing network 1124.

In order to conduct a clearing and settling process for a financial transaction involving a secondary account associated with a second issuer computer 1128 in a linked relationship with a primary account associated with a first issuer computer 1126, according to this embodiment, the merchant computer 1120 may first transmit a settlement file containing transaction details to the acquirer computer 1122.

The settlement file may contain a reconciliation file containing all the transaction details for transactions conducted between the secondary user 1110 and the merchant using the open-to-buy limit or credit limit granted by the primary user 1102 to the secondary account of the secondary user 1110. The settlement file may be submitted periodically throughout the day, or more commonly, at the end of the business day.

After the acquirer computer 1122 associated with a merchant receives the settlement file containing the transactions of the secondary user 1110 from the merchant computer 1120, the acquirer computer 1122 may then route the settlement file to the payment processing network 1124. The payment processing network 1124 receives the settlement file comprising the reconciliation file and transaction details.

The payment processing network 1124 parses the settlement file. The payment processing network 1124 evaluates the contents of the settlement file and determines the appropriate first issuer computer 1126 to which the settlement file can be transmitted. In embodiments of the claimed invention, the server computer in the payment processing network 1124 determines the appropriate first issuer computer 1126 to send the settlement file based on the contents of the settlement file. For example, the server computer in the payment processing network 1124 may parse out the second account identifier 1116(A) contained in the settlement file and access the linked accounts database in the payment processing network 1124 to locate the corresponding linked primary account.

The payment processing may also retrieve the pre-authorization hold ID associated with the secondary account that was generated when the open-to-buy limit of the secondary account was increased with the granted amount from the primary account. The pre-authorization hold ID may then be combined with the transaction details contained in the settlement file to accurately reconcile the transaction against the primary account.

The payment processing network 1124 may then route the settlement file to the appropriate first issuer computer 1126 for the linked primary account using the messaging module and the routing module contained in the server computer of the payment processing network 1124. The payment processing network 1124 can send the settlement file to the first issuer computer 1126 by any appropriate messaging means. The first issuer computer 1126 receives the settlement file comprising transaction details.

The first issuer computer 1126 initiates the transfer of funds from the primary account of the primary user 1102 to the payee (e.g. merchant). In embodiments, the first issuer computer 1126 initiates the process by debiting the transaction amount from the primary account (or by charging the primary account an amount equal to the transaction amount). After receiving the settlement file at the first issuer computer 1126, the first issuer computer 1126 parses the settlement file and determines the pre-authorization hold ID associated with the transaction and locates the appropriate primary account for the transaction. The first issuer computer 1126 charges the transaction amount against the appropriate primary account as an actual purchase. In the example above, the $25 transaction would be charged against the primary account and the $25 in monetary funds would be pulled. Once a transaction with the pre-authorization hold ID is received by the first issuer computer 1126, the pre-authorization hold is canceled. Once the transaction amount is charged against the primary account, the issuer computer 1126 transmits the funds back to the acquirer computer 1122 via the payment processing network 1124.

In this embodiment, a new pre-authorization hold may need to be established. Once the settlement process has completed, the payment processing network 1124 determines whether the secondary account has any open-to-buy limit available. For example, after transactions totaling $55 are is settled, the secondary account still holds an open-to-buy limit of $45. However, since the pre-authorization hold against the primary account was canceled when the transactions were settled, a new pre-authorization hold is needed. The process is similar to that described with respect to FIG. 6. The server computer in the payment processing network 1124 transmits an authorization request message to the first issuer computer 1126. Once the first issuer computer 1126 receives the authorization request message, the first issuer computer 1126 parses the authorization request message for at least the primary account number and secondary account number, the remaining amount of open-to-buy on the secondary card, and the designated hold period. The first issuer computer 1126 initiates an authorization hold on the primary account for the remaining amount of open-to-buy on the secondary card (e.g. $45 in the example) and for the designated hold period. A unique pre-authorization hold ID for the hold would also be generated (e.g. Pre-authorization Hold ID: 34890101). In embodiments, the amount of time the pre-authorization hold is valid matches the frequency for transaction sweeps designated by the primary user 1102. The first issuer computer 1126 then tags the secondary account with the unique pre-authorization hold ID (e.g. Pre-authorization Hold ID: 34890101).

Once the acquirer computer 1122 receives the transaction amount from the first issuer computer 1126, the acquirer computer 1122 credits an account associated with the merchant with the transaction amount.

Another embodiment of the invention involves the secondary account holding an available open-to-buy limit separate from and in addition to any credit granted from a linked primary account. For example, the secondary user may have placed $10 of their own funds on the secondary account, while the primary user, after conducting the linking process previously described, may have granted the secondary user $10 of the primary account's open-to-buy limit or credit limit. In this scenario, the open-to-buy limit of the secondary account would be $20.

The secondary user may then conduct a transaction to purchase a $20 gift card at a merchant by swiping a second payment device at a merchant access device associated with the merchant. The secondary user, alternatively, may have used a second client computer to access a merchant Internet website through a communications network. The merchant computer may generate an authorization request message for the $20 transaction that is sent through an acquirer computer and payment processing network, to an issuer computer associated with the first account and the secondary account. The issuer computer may evaluate the transaction based on settings established by the primary user and then return an authorization response message approving or denying the transaction.

If the transaction is approved, the transaction details are stored in a reconciliation file that is transmitted as part of a settlement file in a clearing and settlement process. The settlement file is sent through the acquirer computer to the payment processing network. The payment processing network may parse the settlement file and determine that the transaction involved a secondary account linked to a primary account. The payment processing network can further determine that the primary user only granted $10 of the open-to-buy limit of the primary account to the secondary account. In this case, the payment processing network may recognize that the clearing and settlement process may need to be separated into two separate clearing and settlement messages: one against the primary account and one against the secondary account. The payment processing network would transmit the settlement to the issuer by sending a first clearing message to the issuer for $10 of monetary funds to be pulled from the first account and a second clearing message for $10 of monetary funds to be pulled from the second account. The issuer computer would debit $10 from the primary account and $10 from the secondary account. The debited funds would then be transmitted through the payment processing network to the acquirer computer associated with the merchant, and the debited funds would be credited to the merchant's account with the acquirer computer.

Another embodiment allows the primary user to create a new account to be treated as a linked secondary account. In addition to the enrollment settings described with respect to FIG. 4, the primary user may be required to input additional information, including, but not limited to, the name of the secondary user and the mailing address of the secondary user. This embodiment may further require an issuer computer associated with the primary user to generate and deliver a second payment device associated with the secondary account, to the secondary user. The second payment device may require activation prior to transactions using the secondary payment device and secondary account being allowed.

In other embodiments, an electronic wallet may be used to conduct a transaction. An electronic wallet may be used in a variety of transactions, including but not limited to eCommerce, social networks, money transfer/personal payments, mobile commerce, proximity payments, gaming, and/or the like. For example, users may engage in eCommerce via the electronic wallet for retail purchases, digital goods purchases, and utility payments. Users, for example, may also use the electronic wallet to purchase games or gaming credits from gaming websites, and transfer funds to friends via social networks. Further, for example, users may also use the electronic wallet on a smart phone for retail purchases, buying digital goods, NFC/RF payments at point of sale (POS) terminals.

In an exemplary transaction involving an electronic wallet, a consumer may submit an indication to purchase or transfer funds. For example, the consumer may visit a merchant website (e.g., Facebook.com, Amazon.com, etc.), and request to purchase an item from the website, transfer funds to a friend, and/or the like. The merchant website may determine whether the electronic wallet is authorized on its website, and may provide a list of payment options. If the merchant is registered with an electronic wallet server, the electronic wallet server may authorize the merchant to collect consumer credentials for login to the electronic wallet, and the merchant website may prompt the consumer to login to the electronic wallet. Otherwise, the merchant website may request the consumer to provide payment details for alternative payment options (e.g., credit card, debit card, PayPal account).

The consumer may authorize submission of their wallet consumer credentials, such as, but not limited to a Wallet/User ID, a password, and/or the like. For example, the consumer may enter the Wallet/User ID and password into a pop-up window provided from the merchant website and/or electronic wallet server. In another example, the consumer may authorize the merchant website to provide the consumer credentials (e.g., previously stored in HTML5, cookies, etc.), to the electronic wallet server. In yet another example, the consumer may authorize the electronic wallet server, via a remote component running on the merchant website (e.g., a Java applet, etc.) to provide consumer credentials to the electronic wallet server for verification.

When the consumer submits consumer credentials to log into the electronic wallet, the merchant website may forward the consumer credentials and transaction details to the electronic wallet server, which may determine the validity of the consumer credentials. If the consumer's credentials are not valid, the electronic wallet server may deny the payment request and send a notification of denial to the merchant website. In other embodiments, if the consumer provided credentials are valid, the electronic wallet server may process payment from the electronic wallet. For example, the electronic wallet server communicates with the consumer's bank account associated with the electronic wallet and requests a fund transfer of an indicated amount. The electronic wallet server may then store a transaction record.

In some embodiments, after processing the payment, the electronic wallet server sends a payment confirmation notice to the merchant website, which in turn completes the order and stores the transaction record in the database. The merchant website may provide a confirmation page comprising transaction confirmation to the consumer.

### V. Exemplary Computer Apparatuses

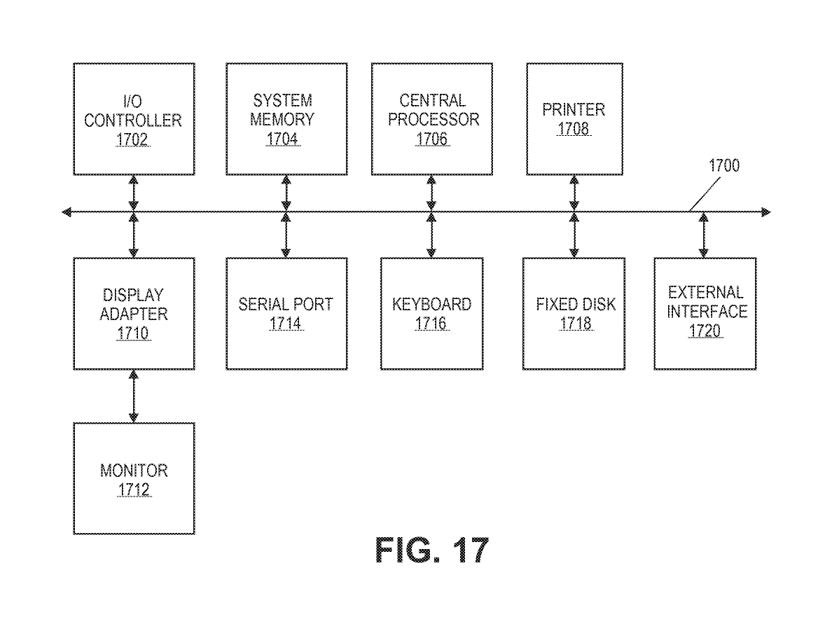

The various participants and elements may operate one or more computer apparatuses (e.g., a server computer) to facilitate the functions described herein. Any of the elements in the figures may use any suitable number of subsystems to facilitate the functions described herein. Examples of such subsystems or components are shown in FIG. 17. The subsystems shown in FIG. 17 are interconnected via a system bus 1700. Additional subsystems such as a printer 1708, keyboard 1716, fixed disk 1718 (or other memory comprising computer readable media), monitor 1712, which is coupled to display adapter 1710, and others are shown. Peripherals and input/output (I/O) devices, which couple to I/O controller 1702, can be connected to the computer system by any number of means known in the art, such as serial port 1714. For example, serial port 1714 or external interface 1720 can be used to connect the computer apparatus to a wide area network such as the Internet, a mouse input device, or a scanner. The interconnection via system bus 1700 allows the central processor 1706 to communicate with each subsystem and to control the execution of instructions from system memory 1704 or the fixed disk 1718, as well as the exchange of information between subsystems. The system memory 1704 and/or the fixed disk 1718 may embody a computer readable medium.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited in this patent are hereby incorporated by reference for all purposes.

One or more features from any embodiment may be combined with one or more features of any other embodiment without departing from the scope of the disclosure.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

1-26. (canceled)

27. A method comprising:
receiving, by a processor computer in a payment processing network, configuration data including an allocation amount of an account limit of the first account to allocate to the second account for use by the second account in transactions, the first account being associated with a credit card and the second account being associated with a debit card;
sending, by the processor computer to an issuer computer associated with the first account, a first pre-authorization hold request message including a first account number of the first account, a second account number of the second account, and the allocation amount, wherein the issuer computer establishes a first pre-authorization hold on the first account for the allocation amount and establishes a second account limit for the second account by the allocation amount;
sending, by the processor computer to the issuer computer, an authorization request message comprising a transaction amount for a transaction on the second account, wherein the issuer computer thereafter reduces the second account limit of the second account by the transaction amount to form a reduced second account limit and records transaction details for the transaction on the second account;
modifying, by the processor computer, a settlement file containing the transaction details for the transaction to form a modified settlement file by including an identifier of the first pre-authorization hold with the transaction details such that the issuer computer can reconcile the transaction on the second account against the first pre-authorization hold on the first account; and
sending, by the processor computer to the issuer computer, the modified settlement file, wherein the issuer computer initiates a transfer of funds for the transaction amount from the first account a merchant based on the transaction details, records the transaction details and the second account number of the second account on the first account, cancels the first pre-authorization hold, cancels the first pre-authorization hold, and establishes a second pre-authorization hold on the first account for the reduced second account limit.

28. The method of claim 27, wherein the allocation amount is less than a credit limit imposed on the first account.

29. The method of claim 28, wherein the allocation amount is less than fifty percent of the credit limit imposed on the first account.

30. The method of claim 27, further comprising:
receiving, by the processor computer, severance data unlinking the first account from the second account, wherein after receiving the severance data, the second account is capable of being used independently of the first account.

31. The method of claim 27, wherein the authorization request message is in the form of an ISO 8583 message.

32. The method of claim 27, wherein the configuration data further includes restrictions on the use of the allocation amount.

33. The method of claim 27, further comprising:
sending, by the processor computer, a reverse transaction message for the transaction to the issuer computer, wherein the issuer computer increases the second account limit of the second account by the transaction amount and initiates a second transfer of funds for the transaction amount from the merchant to the first account.

34. The method of claim 27, further comprising:
receiving, by the processor computer from the issuer computer, the identifier of the first pre-authorization hold, wherein the issuer computer tags the second account with the identifier of the first pre-authorization hold; and
storing, by the processor computer, the identifier of the first pre-authorization hold for use in a settlement process.

35. The method of claim 27, further comprising:
storing, by the processor computer, the configuration data in a database, the database associating the first account number of the first account, the second account number of the second account, and the allocation amount;
receiving, by the processor computer from a merchant computer associated with the merchant, the settlement file;
parsing, by the processor computer, the settlement file to identify the second account number; and
identifying, by the processor computer using the database, the first account associated with the second account number.

36. The method of claim 27, wherein the first pre-authorization hold request message indicates a hold period for the first pre-authorization hold, and wherein the sending of the authorization request message occurs during the hold period.

37. A server computer in a payment processing network, the server computer comprising a processor and a computer readable medium coupled to the processor, the computer readable medium comprising code for implementing a method comprising:
receiving configuration data including an allocation amount of an account limit of a first account to allocate to a second account for use by the second account in transactions, the first account being associated with a credit card and the second account being associated with a debit card;
sending, to an issuer computer associated with the first account, a first pre-authorization hold request message including a first account number of the first account, a second account number of the second account, and the allocation amount, wherein the issuer computer establishes a first pre-authorization hold on the first account for the allocation amount and establishes a second account limit for the second account by the allocation amount;
sending, to the issuer computer, an authorization request message comprising a transaction amount for a transaction on the second account, wherein the issuer computer thereafter reduces the second account limit of the second account by the transaction amount to form a reduced second account limit and records transaction details for the transaction on the second account;
modifying a settlement file containing the transaction details for the transaction to form a modified settlement file by including an identifier of the first pre-authorization hold with the transaction details such that the issuer computer can reconcile the transaction on the second account against the first pre-authorization hold on the first account; and
sending, to the issuer computer, the modified settlement file, wherein the issuer computer initiates a transfer of funds for the transaction amount from the first account to a merchant based on the transaction details, records the transaction details and the second account number on the first account, cancels the first pre-authorization hold, and establishes a second pre-authorization hold on the first account for the reduced second account limit.

38. The server computer of claim 37, wherein the allocation amount is less than a credit limit imposed on the first account.

39. The server computer of claim 38, wherein the allocation amount is less than fifty percent of the credit limit imposed on the first account.

40. The server computer of claim 37, wherein the method implemented by the code further comprises:
receiving severance data unlinking the first account from the second account, wherein after receiving the severance data, the second account is capable of being used independently of the first account.

41. The server computer of claim 37, wherein the authorization request message is in the form of an ISO 8583 message.

42. The server computer of claim 37, wherein the configuration data further includes restrictions on the use of the allocation amount.

43. The server computer of claim 37, wherein the method implemented by the code further comprises:
sending a reverse transaction message for the transaction to the issuer computer, wherein the issuer computer increases the second account limit of the second account by the transaction amount and initiates a second transfer of funds for the transaction amount from the payee to the first account.

44. The server computer of claim 37, wherein the method implemented by the code further comprises:
receiving, from the issuer computer, the identifier of the first pre-authorization hold, wherein the issuer computer tags the second account with the identifier of the first pre-authorization hold; and
storing the identifier of the first pre-authorization hold for use in a settlement process.

45. The server computer of claim 37, wherein the method implemented by the code further comprises:
storing the configuration data in a database, the database associating the first account number of the first account, the second account number of the second account, and the allocation amount;
receiving, from a merchant computer associated with the merchant, the settlement file;
parsing the settlement file to identify the second account number; and
identifying, using the database, the first account associated with the second account number.

46. The server computer of claim 37, wherein the first pre-authorization hold request message indicates a hold period for the first pre-authorization hold, and wherein the sending of the authorization request message occurs during the hold period.
